(19) United States
(12) Patent Application Publication
(10) Pub. No.: US 2022/0038474 A1
(43) Pub. Date: Feb. 3, 2022

(54) METHOD AND SYSTEM THAT ENHANCES COMPUTER-SYSTEM SECURITY BY IDENTIFYING AND BLOCKING HARMFUL COMMUNICATIONS THROUGH COMPONENT INTERFACES

(71) Applicant: Dev Ayan Nag, Larkspur, CA (US)

(72) Inventor: Dev Ayan Nag, Larkspur, CA (US)

(21) Appl. No.: 17/391,015

(22) Filed: Aug. 1, 2021

Related U.S. Application Data
(60) Provisional application No. 63/059,846, filed on Jul. 31, 2020.

(51) Int. Cl. H04L 29/06; G06N 20/00

(52) U.S. Cl. CPC H04L 63/1416; G06N 20/00; H04L 63/10

(57) ABSTRACT

The current document is directed to methods and systems that monitor communications through system-component interfaces to detect and block harmful requests and other harmful communications. In a disclosed implementation, a machine-learning-based defender security component is trained, using a minimax-based optimization method similar to that used in generative adversarial networks, to recognize harmful requests and other harmful communications intercepted by the defender from any of various communications paths leading to system-component interfaces, such as a service interface to services provided by a distributed application. The defender passes through harmless messages to their target interfaces and takes various actions with respect to detected harmful messages, including blocking the harmful messages, modifying the harmful messages prior to passing them through to their target interfaces, and other actions.

### CROSS-REFERENCE TO RELATED APPLICATION

This application claims the benefit of U.S. Provisional Application No. 63/059,846, filed Jul. 31, 2020.

### TECHNICAL FIELD

The current document is directed to computer-system security and, in particular, to methods and systems that monitor communications through system-component interfaces to detect and block harmful requests and other harmful communications.

### BACKGROUND

During the past seven decades, electronic computing has evolved from primitive, vacuum-tube-based computer systems, initially developed during the 1940s, to modern electronic computer systems in which large numbers of multi-processor servers, work stations, and other individual computer systems are networked together with large-capacity data-storage devices and other electronic devices to produce geographically distributed computer systems with hundreds of thousands, millions, or more components that provide enormous computational bandwidths and data-storage capacities. These large, distributed computer systems are made possible by advances in computer networking, distributed operating systems and applications, data-storage appliances, and computer-hardware and computer-software technologies.

As the complexity of distributed computer systems has increased, the exposure of distributed systems to various types of malicious attacks has increased dramatically. The very complex distributed-computer systems now providing widely used services and functionalities, including services provided, through the Internet, by distributed applications that implement web sites, are increasingly vulnerable to malicious exploitation of security breaches and management oversights that can lead to serious failures of computational infrastructure, theft, fraud, and cascading disruptions and damage that threaten individuals, organizations, and society, as a whole. Large amounts of time, money, and human and computational resources are currently devoted to monitoring computer systems to detect and deflect various types of malicious attacks and threats, but as security systems increase in capabilities, attackers increase in sophistication and capability, resulting in a constant race in which security systems often lag the new approaches taken by malicious attackers. Therefore, designers, developers, and, ultimately, users of various types of computer systems, including distributed computer systems, continue to seek new approaches to implementing security systems and procedures to prevent harmful attacks directed to computer systems.

### SUMMARY

The current document is directed to methods and systems that monitor communications through system-component interfaces to detect and block harmful requests and other harmful communications. In a disclosed implementation, a machine-learning-based defender security component is trained, using a minimax-based optimization method similar to that used in generative adversarial networks, to recognize harmful requests and other harmful communications intercepted by the defender from any of various communications paths leading to system-component interfaces, such as a service interface to services provided by a distributed application. The defender passes through harmless messages to their target interfaces and takes various actions with respect to detected harmful messages, including blocking the harmful messages, modifying the harmful messages prior to passing them through to their target interfaces, and other actions.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates the fundamental components of a feed-forward neural network.

FIG. 7 illustrates a small, example feed-forward neural network.

FIG. 8 provides a concise pseudocode illustration of the implementation of a simple feed-forward neural network.

FIG. 9 illustrates back propagation of errors through the neural network during training.

FIGS. 10A-B show the details of the weight-adjustment calculations carried out during back propagation.

FIGS. 11A-B illustrate various aspects of recurrent neural networks.

FIGS. 12A-C illustrate a convolutional neural network.

FIG. 13A-B illustrate neural-network training as an example of machine-learning-based-subsystem training.

FIG. 14 illustrates two of many different types of neural networks.

FIG. 15 provides an illustration of the general characteristics and operation of a reinforcement-learning control system.

FIG. 16 illustrates certain details of one class of reinforcement-learning system.

FIG. 17 illustrates learning of a near-optimal or optimal policy by a reinforcement-learning agent.

FIG. 18 illustrates one type of reinforcement-learning system the falls within a class of reinforcement-learning systems referred to as “actor-critic” systems.

FIGS. 19A-B illustrate a generalized deterministic, two-player, zero-sum game of perfect information used to illustrate the minimax adversarial search method.

FIGS. 20A-B provide control-flow diagrams that illustrate the minimax-optimal-decision method.

FIGS. 21A-B illustrate a generative function.

FIG. 22 provides an illustration of the generative-adversarial-network method for simultaneously training a generator G, which simulates a generative function, and a discriminator D, which produces a probability value in the range [0, 1].

FIGS. 23A-C illustrate a generative-adversarial-network method for concurrently training a generator neural network G and a discriminator neural network D.

FIGS. 24A-B illustrates a problem domain used as an example of an application of the currently disclosed methods and systems.

FIG. 25 illustrates a system-health-evaluation method that is used in implementations of the disclosed methods and systems, discussed below.

FIGS. 26A-B illustrate sets of vectors representing requests that a defender security component representing one implementation of the currently disclosed systems is trained to distinguish.

FIGS. 27A-C illustrate operation of the defender security component representing one implementation of the currently disclosed systems.

FIG. 28 illustrates how the defender neural network is trained using a training method similar to the above-discussed generative-adversarial-network training method.

FIGS. 29A-B illustrate two different objective values that control adversarial training of the defender security component that represents an implementation of the currently disclosed systems.

FIG. 30 shows an alternative implementation of the defender based on reinforcement learning.

FIG. 31 illustrates a simple model for evaluating the harmfulness of requests used in an illustrative implementation, discussed below.

FIGS. 32-33F provide a Python illustrative implementation of defender and hacker training.

### DETAILED DESCRIPTION

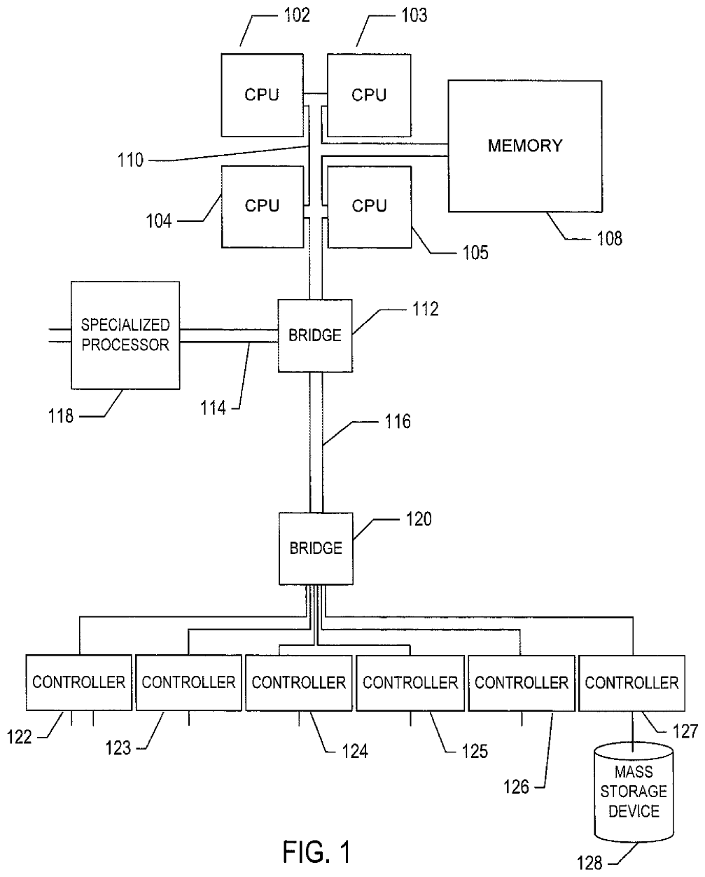

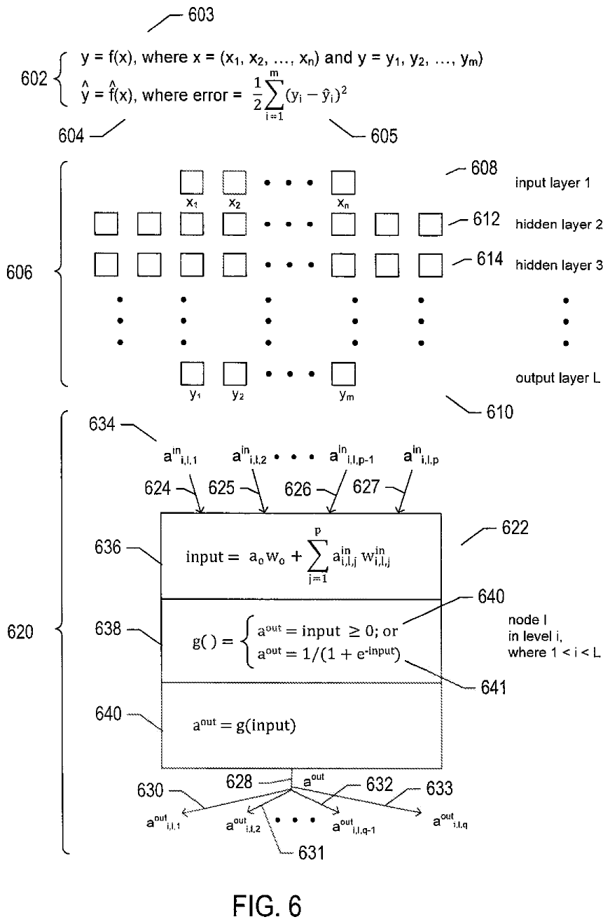

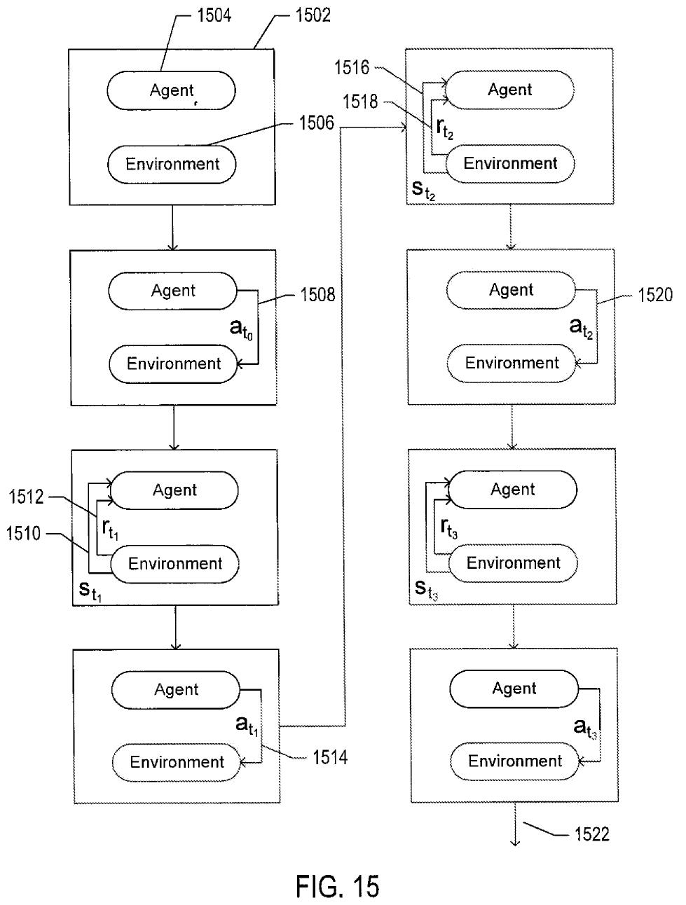

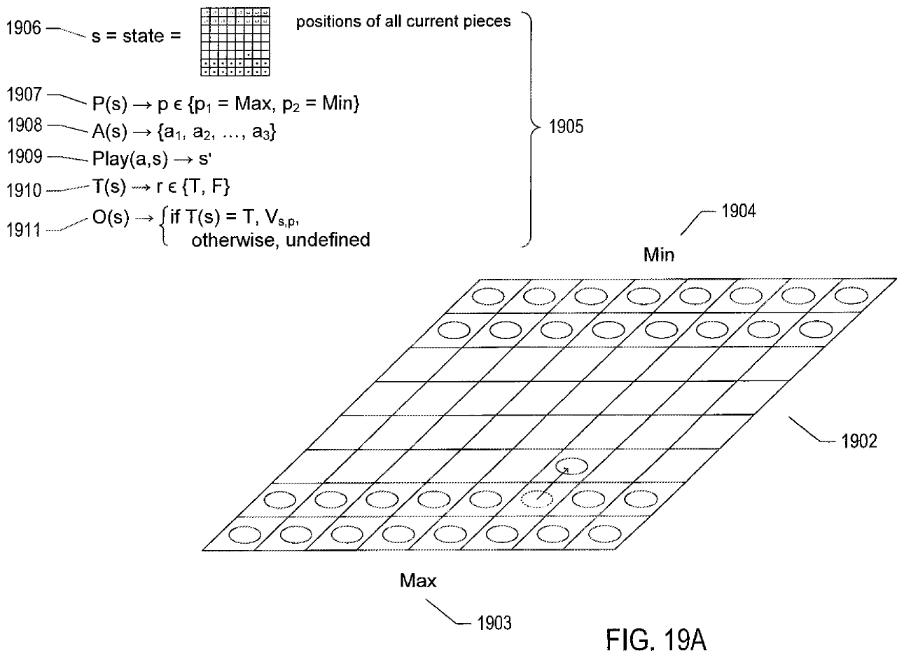

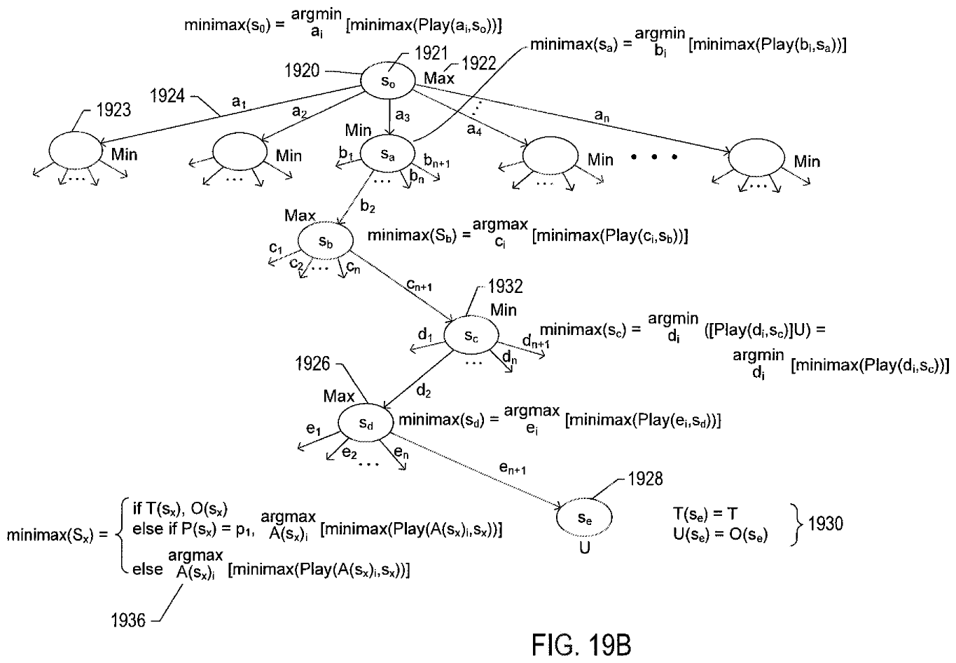

The current document is directed to methods and systems that provide enhanced security with respect to communications within computer systems. In a first subsection, below, a description of computer hardware, complex computational systems, and virtualization is provided with reference to FIGS. 1-5B. In a second subsection, neural networks are discussed with reference to FIGS. 6-14. In a third subsection, reinforcement learning is discussed with reference to FIGS. 15-18. In final subsection, the currently disclosed systems and methods are discussed with reference to FIGS. 19A-29B.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

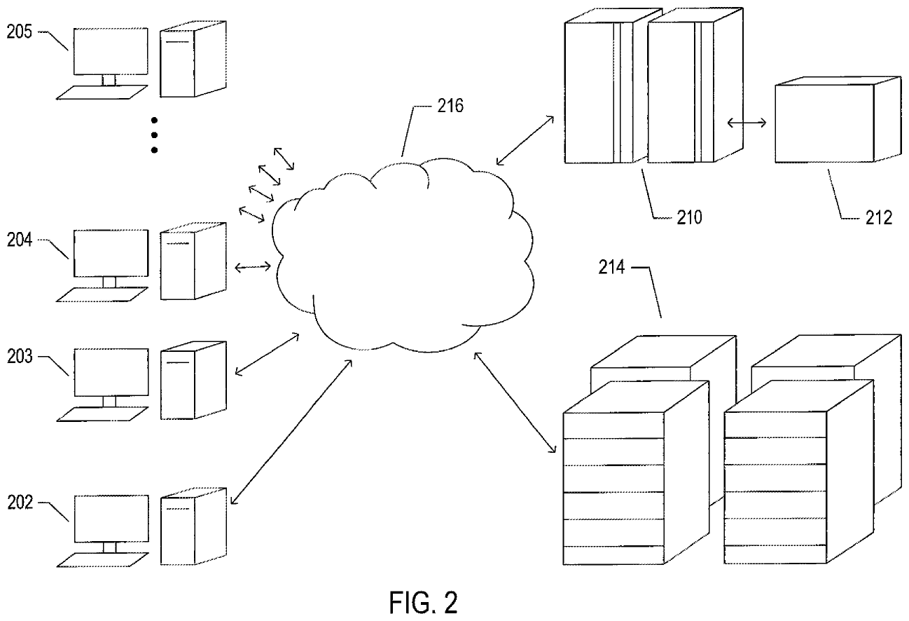

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

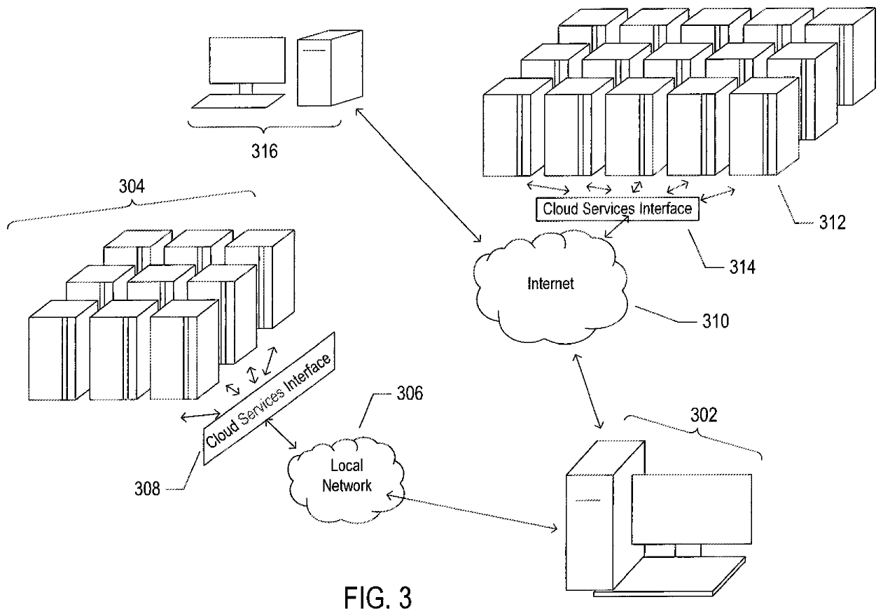

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

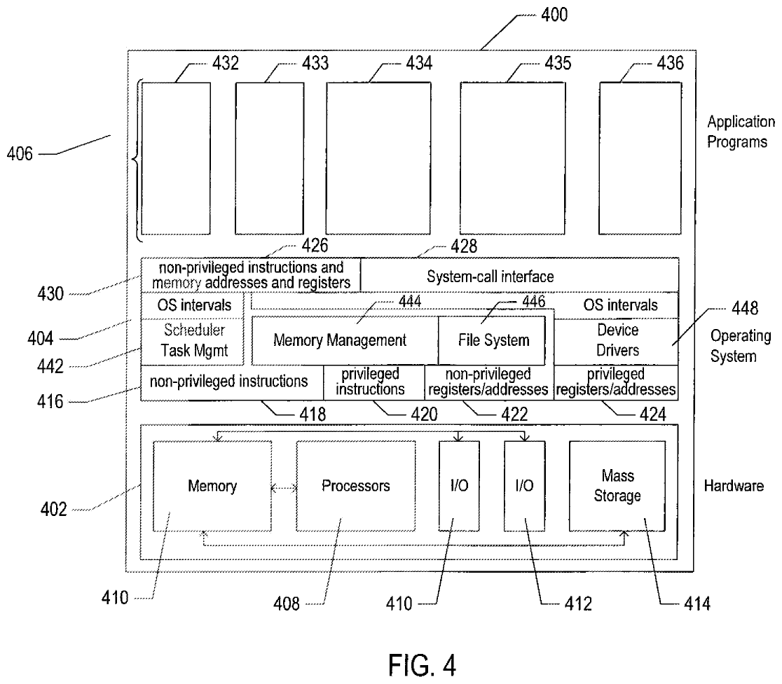

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

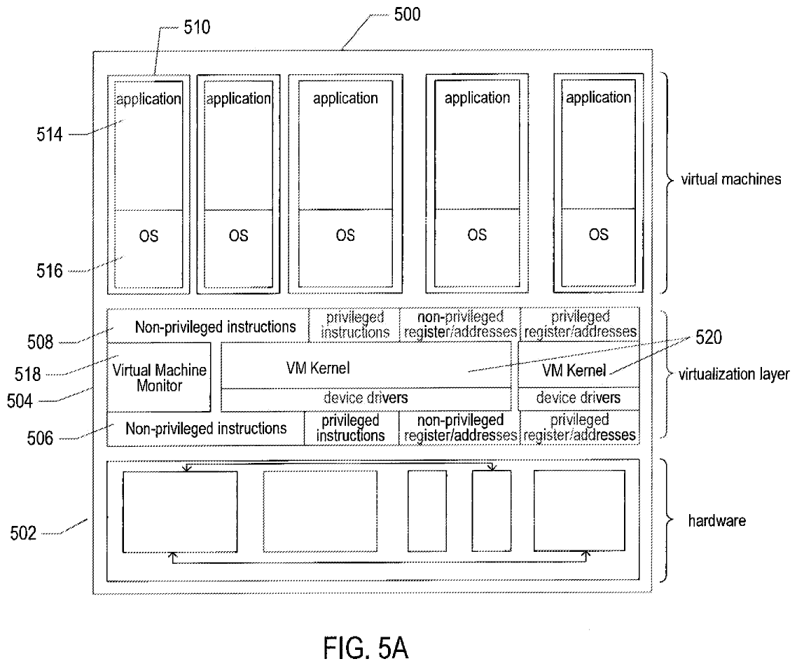

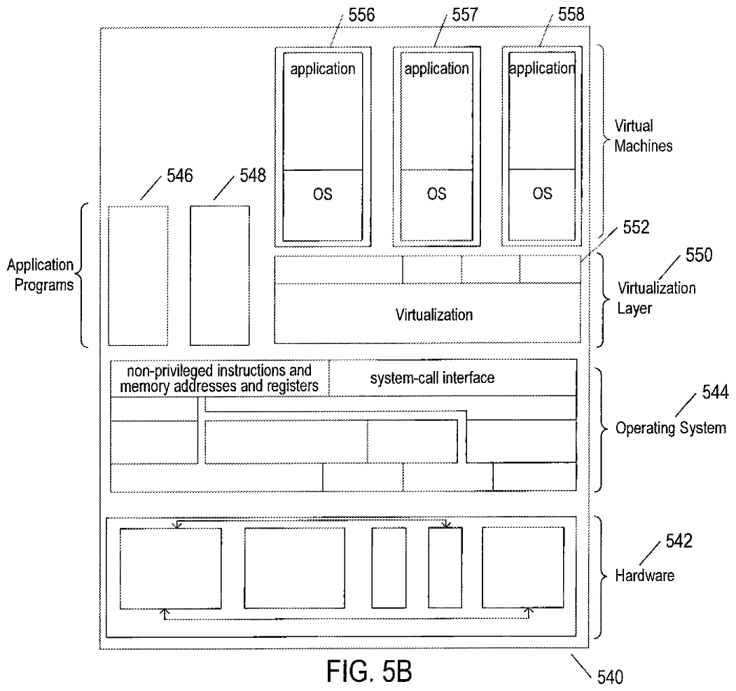

For all of these reasons, a higher level of abstraction, referred to as the “virtual machine.” has been developed and evolved to further abstract computer hardware in order to address many difficulties and challenges associated with traditional computer systems, including the compatibility issues discussed above. FIGS. 5A-D illustrate several types of virtual machine and virtual-machine execution environments. FIGS. 5A-B use the same illustration conventions as used in FIG. 4. Figure SA shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS.” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

### Neural Networks

FIG. 6 illustrates the fundamental components of a feed-forward neural network. Equations 602 mathematically represents ideal operation of a neural network as a function ƒ(x). The function receives an input vector x and outputs a corresponding output vector y 603. For example, an input vector may be a digital image represented by a two-dimensional array of pixel values in an electronic document or may be an ordered set of numeric or alphanumeric values. Similarly, the output vector may be, for example, an altered digital image, an ordered set of one or more numeric or alphanumeric values, an electronic document, or one or more numeric values. The initial expression 603 represents the ideal operation of the neural network. In other words, the output vectors y represent the ideal, or desired, output for corresponding input vector x. However, in actual operation, a physically implemented neural network \hat{ƒ}(x), as represented by expressions 604, returns a physically generated output vector ŷ that may differ from the ideal or desired output vector y. As shown in the second expression 605 within expressions 604, an output vector produced by the physically implemented neural network is associated with an error or loss value. A common error or loss value is the square of the distance between the two points represented by the ideal output vector and the output vector produced by the neural network. To simplify back-propagation computations, discussed below, the square of the distance is often divided by 2. As further discussed below, the distance between the two points represented by the ideal output vector and the output vector produced by the neural network, with optional scaling, may also be used as the error or loss. A neural network is trained using a training dataset comprising input-vector/ideal-output-vector pairs, generally obtained by human or human-assisted assignment of ideal-output vectors to selected input vectors. The ideal-output vectors in the training dataset are often referred to as “labels.” During training, the error associated with each output vector, produced by the neural network in response to input to the neural network of a training-dataset input vector, is used to adjust internal weights within the neural network in order to minimize the error or loss. Thus, the accuracy and reliability of a trained neural network is highly dependent on the accuracy and completeness of the training dataset.

As shown in the middle portion 606 of FIG. 6, a feed-forward neural network generally consists of layers of nodes, including an input layer 608, and output layer 610, and one or more hidden layers 612 and 614. These layers can be numerically labeled 1, 2, 3, . . . , L, as shown in FIG. 6. In general, the input layer contains a node for each element of the input vector and the output layer contains one node for each element of the output vector. The input layer and/or output layer may have one or more nodes. In the following discussion, the nodes of a first level with a numeric label lower in value than that of a second layer are referred to as being higher-level nodes with respect to the nodes of the second layer. The input-layer nodes are thus the highest-level nodes. The nodes are interconnected to form a graph.

The lower portion of FIG. 6 (620 in FIG. 6) illustrates a feed-forward neural-network node. The neural-network node 622 receives inputs 624-627 from one or more next-higher-level nodes and generates an output 628 that is distributed to one or more next-lower-level nodes 630-633. The inputs and outputs are referred to as “activations,” represented by superscripted-and-subscripted symbols “a” in FIG. 6, such as the activation symbol 634. An input component 636 within a node collects the input activations and generates a weighted sum of these input activations to which a weighted internal activation a₀ is added. An activation component 638 within the node is represented by a function g( ), referred to as an “activation function,” that is used in an output component 640 of the node to generate the output activation of the node based on the input collected by the input component 636. The neural-network node 622 represents a generic hidden-layer node. Input-layer nodes lack the input component 636 and each receive a single input value representing an element of an input vector. Output-component nodes output a single value representing an element of the output vector. The values of the weights used to generate the cumulative input by the input component 636 are determined by training, as previously mentioned. In general, the input, outputs, and activation function are predetermined and constant, although, in certain types of neural networks, these may also be at least partly adjustable parameters. In FIG. 6, two different possible activation functions are indicated by expressions 640 and 641. The latter expression represents a sigmoidal relationship between input and output that is commonly used in neural networks and other types of machine-learning systems.

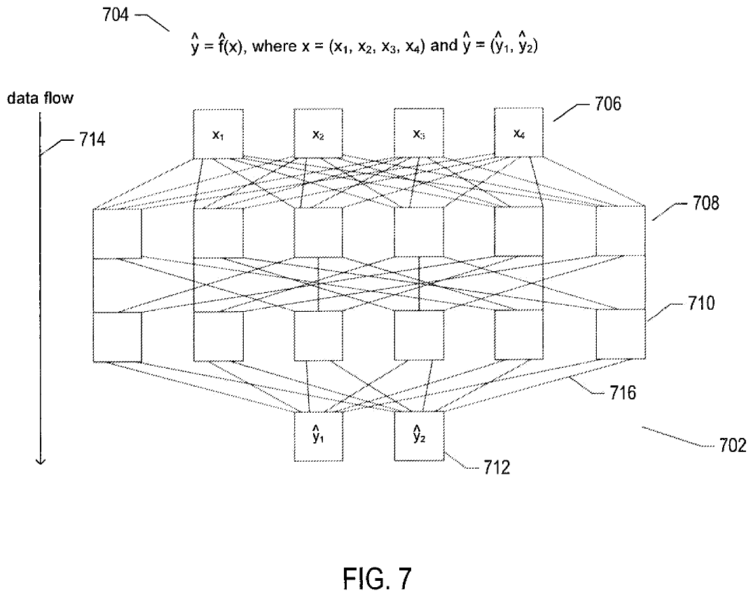

FIG. 7 illustrates a small, example feed-forward neural network. The example neural network 702 is mathematically represented by expression 704. It includes an input layer of four nodes 706, a first hidden layer 708 of six nodes, a second hidden layer 710 of six nodes, and an output layer 712 of two nodes. As indicated by directed arrow 714, data input to the input-layer nodes 706 flows downward through the neural network to produce the final values output by the output nodes in the output layer 712. The line segments, such as line segment 716, interconnecting the nodes in the neural network 702 indicate communications paths along which activations are transmitted from higher-level nodes to lower-level nodes. In the example feed-forward neural network, the nodes of the input layer 706 are fully connected to the nodes of the first hidden layer 708, but the nodes of the first hidden layer 708 are only sparsely connected with the nodes of the second hidden layer 710. Various different types of neural networks may use different numbers of layers, different numbers of nodes in each of the layers, and different patterns of connections between the nodes of each layer to the nodes in preceding and succeeding layers.

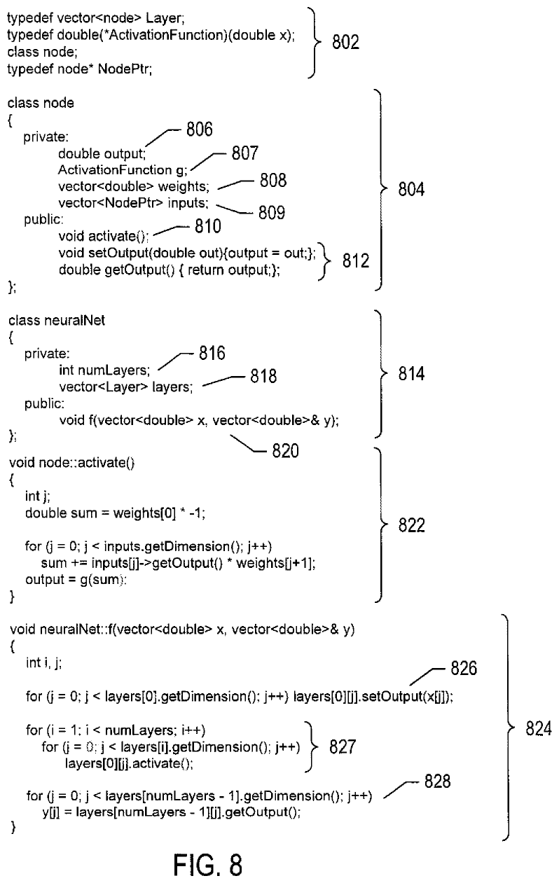

FIG. 8 provides a concise pseudocode illustration of the implementation of a simple feed-forward neural network. Three initial type definitions 802 provide types for layers of nodes, pointers to activation functions, and pointers to nodes. The class node 804 represents a neural-network node. Each node includes the following data members: (1) output 806, the output activation value for the node. (2) g 807, a pointer to the activation function for the node; (3) weights 808, the weights associated with the inputs; and (4) inputs 809, pointers to the higher-level nodes from which the node receives activations. Each node provides an activate member function 810 that generates the activation for the node, which is stored in the data member output, and a pair of member functions 812 for setting and getting the value stored in the data member output. The class neuralNet 814 represents an entire neural network. The neural network includes data members that store the number of layers 816 and a vector of node-vector layers 818, each node-vector layer representing a layer of nodes within the neural network. The single member function ƒ 820 of the class neuralNet generates an output vector y for an input vector x. An implementation of the member function activate for the node class is next provided 822. This corresponds to the expression shown for the input component 636 in FIG. 6. Finally, an implementation for the member function ƒ 824 of the neuralNet class is provided. In a first for-loop 826, an element of the input vector is input to each of the input-layer nodes. In a pair of nested for-loops 827, the activate function for each hidden-layer and output-layer node in the neural network is called, starting from the highest hidden layer and proceeding layer-by-layer to the output layer. In a final for-loop 828, the activation values of the output-layer nodes are collected into the output vector y.

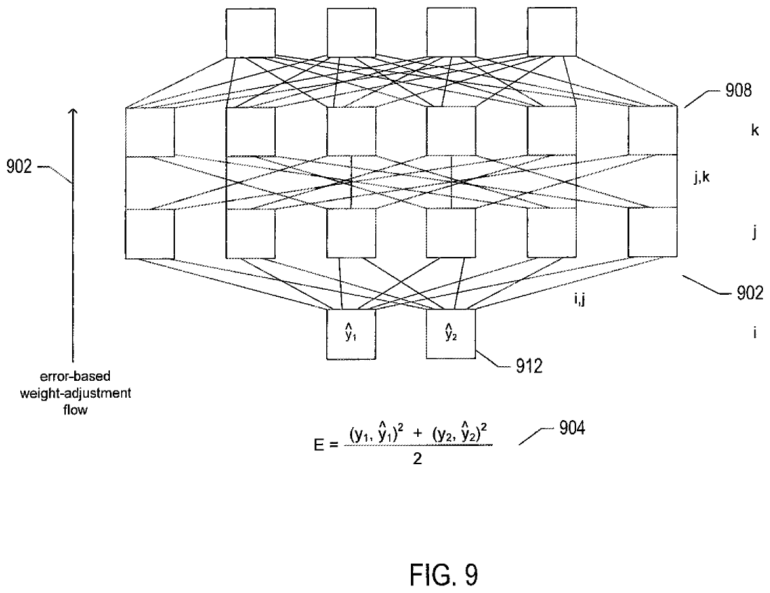

FIG. 9, using the same illustration conventions as used in FIG. 7, illustrates back propagation of errors through the neural network during training. As indicated by directed arrow 902, the error-based weight adjustment flows upward from the output-layer nodes 712 to the highest-level hidden-layer nodes 708. For the example neural network 702, the error, or loss, is computed according to expression 904. This loss is propagated upward through the connections between nodes in a process that proceeds in an opposite direction from the direction of activation transmission during generation of the output vector from the input vector. The back-propagation process determines, for each activation passed from one node to another, the value of the partial differential of the error, or loss, with respect to the weight associated with the activation. This value is then used to adjust the weight in order to minimize the error, or loss.

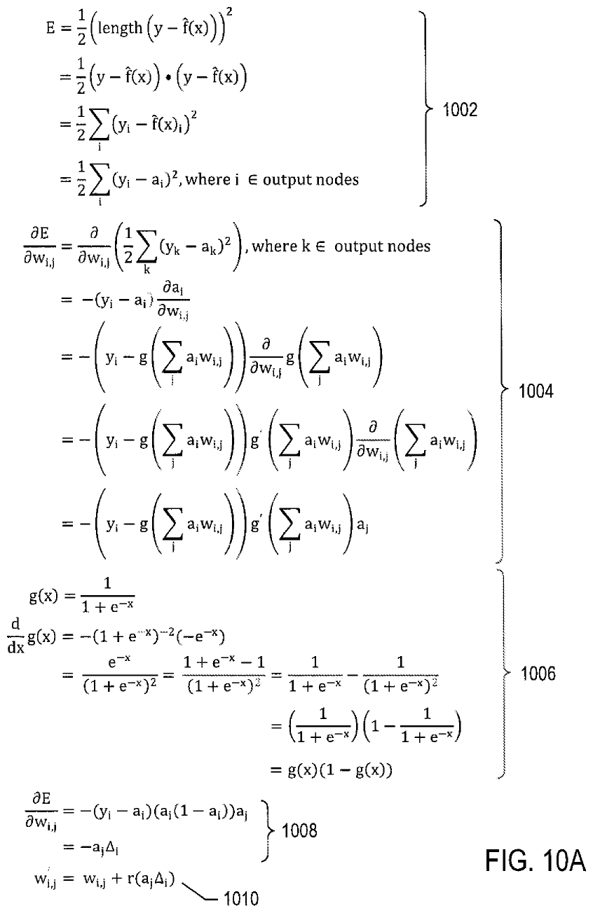

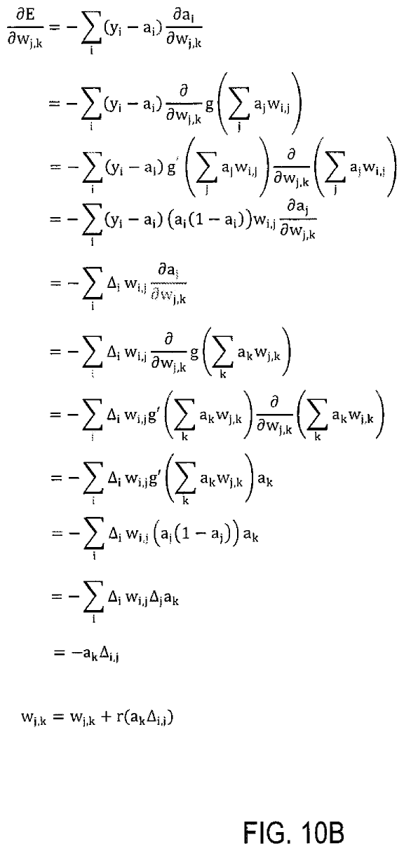

FIGS. 10A-B show the details of the weight-adjustment calculations carried out during back propagation. An expression for the total error, or loss. E with respect to an input-vector/label pair within a training dataset is obtained in a first set of expressions 1002, which is one half the squared distance between the points in a multidimensional space represented by the ideal output and the output vector generated by the neural network. The partial differential of the total error E with respect to a particular weight w_{i,j} for the j^{th} input of an output node i is obtained by the set of expressions 1004. In these expressions, the partial differential operator is propagated rightward through the expression for the total error E. An expression for the derivative of the activation function with respect to the input x produced by the input component of a node is obtained by the set of expressions 1006. This allows for generation of a simplified expression for the partial derivative of the total energy E with respect to the weight associated with the j^{th} input of the i^{th} output node 1008. The weight adjustment based on the total error E is provided by expression 1010, in which r has a real value in the range [0-1] that represents a learning rate, aⱼ is the activation received through input j by node i, and Δᵢ is the product of parenthesized terms, which include aᵢ and yᵢ, in the first expression in expressions 1008 that multiplies aᵢ FIG. 10B provides a derivation of the weight adjustment for the hidden-layer nodes above the output layer. It should be noted that the computational overhead for calculating the weights for each next highest layer of nodes increases geometrically, as indicated by the increasing number of subscripts for the Δ multipliers in the weight-adjustment expressions.

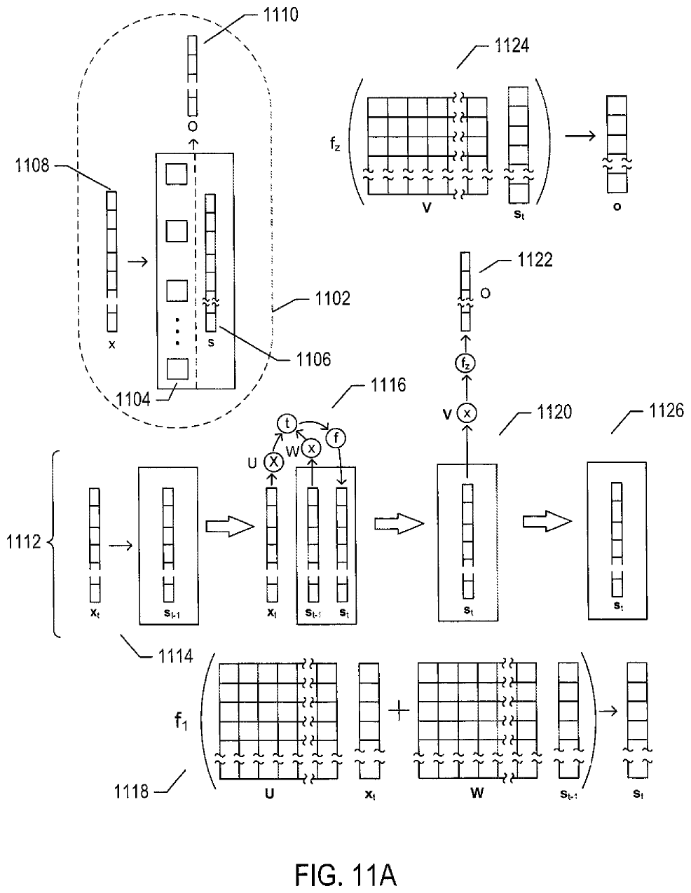

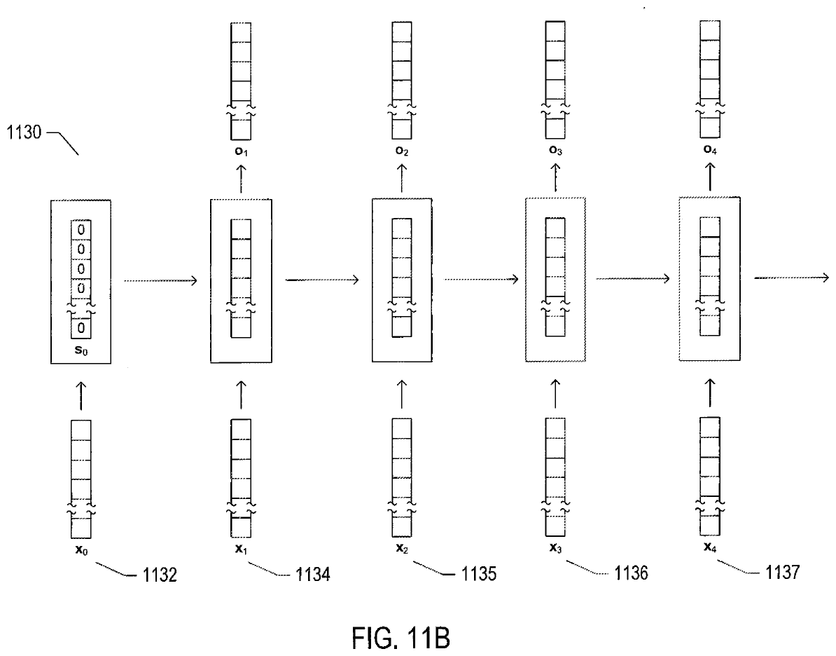

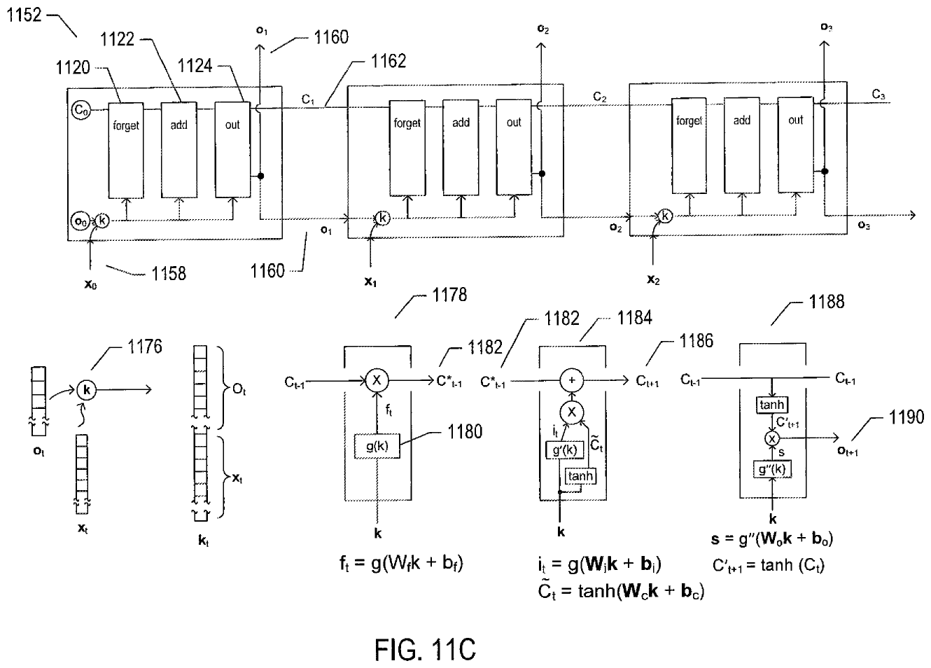

A second type of neural network, referred to as a “recurrent neural network,” is employed to generate sequences of output vectors from sequences of input vectors. These types of neural networks are often used for natural-language applications in which a sequence of words forming a sentence are sequentially processed to produce a translation of the sentence, as one example. FIGS. 11A-B illustrate various aspects of recurrent neural networks. Inset 1102 in FIG. 11A shows a representation of a set of nodes within a recurrent neural network. The set of nodes includes nodes that are implemented similarly to those discussed above with respect to the feed-forward neural network 1104, but additionally include an internal state 1106. In other words, the nodes of a recurrent neural network include a memory component. The set of recurrent-neural-network nodes, at a particular time point in a sequence of time points, receives an input vector x 1108 and produces an output vector 1110. The process of receiving an input vector and producing an output vector is shown in the horizontal set of recurrent-neural-network-nodes diagrams interleaved with large arrows 1112 in FIG. 11A. In a first step 1114, the input vector x at time t is input to the set of recurrent-neural-network nodes which include an internal state generated at time t−1. In a second step 1116, the input vector is multiplied by a set of weights U and the current state vector is multiplied by a set of weights W to produce two vector products which are added together to generate the state vector for time t. This operation is illustrated as a vector function ƒ₁ 1118 in the lower portion of FIG. 11A. In a next step 1120, the current state vector is multiplied by a set of weights V to produce the output vector for time t 1122, a process illustrated as a vector function ƒ₂ 1124 in FIG. 11A. Finally, the recurrent-neural-network nodes are ready for input of a next input vector at time t+1, in step 1126.

FIG. 11B illustrates processing by the set of recurrent-neural-network nodes of a series of input vectors to produce a series of output vectors. At a first time t₀ 1130, a first input vector x₀ 1132 is input to the set of recurrent-neural-network nodes. At each successive time point 1134-1137, a next input vector is input to the set of recurrent-neural-network nodes and an output vector is generated by the set of recurrent-neural-network nodes. In many cases, only a subset of the output vectors are used. Back propagation of the error or loss during training of a recurrent neural network is similar to back propagation for a feed-forward neural network, except that the total error or loss needs to be back-propagated through time in addition to through the nodes of the recurrent neural network. This can be accomplished by unrolling the recurrent neural network to generate a sequence of component neural networks and by then back-propagating the error or loss through this sequence of component neural networks from the most recent time to the most distant time period.

Finally, for completeness. FIG. 11C illustrates a type of recurrent-neural-network node referred to as a long-short-term-memory (“LSTM”) node. In FIG. 11C, a LSTM node 1152 is shown at three successive points in time 1154-1156. State vectors and output vectors appear to be passed between different nodes, but these horizontal connections instead illustrate the fact that the output vector and state vector are stored within the LSTM node at one point in time for use at the next point in time. At each time point, the LSTM node receives an input vector 1158 and outputs an output vector 1160. In addition, the LSTM node outputs a current state 1162 forward in time. The LSTM node includes a forget module 1170, an add module 1172, and an out module 1174. Operations of these modules are shown in the lower portion of FIG. 11C. First, the output vector produced at the previous time point and the input vector received at a current time point are concatenated to produce a vector k 1176. The forget module 1178 computes a set of multipliers 1180 that are used to element-by-element multiply the state from time t−1 in order to produce an altered state 1182. This allows the forget module to delete or diminish certain elements of the state vector. The add module 2134 employs an activation function to generate a new state 1186 from the altered state 1182. Finally, the out module 1188 applies an activation function to generate an output vector 2140 based on the new state and the vector k. An LSTM node, unlike the recurrent-neural-network node illustrated in FIG. 11A, can selectively alter the internal state to reinforce certain components of the state and deemphasize or forget other components of the state in a manner reminiscent of human short-term memory. As one example, when processing a paragraph of text, the LSTM node may reinforce certain components of the state vector in response to receiving new input related to previous input but may diminish components of the state vector when the new input is unrelated to the previous input, which allows the LSTM to adjust its context to emphasize inputs close in time and to slowly diminish the effects of inputs that are not reinforced by subsequent inputs. Here again, back propagation of a total error or loss is employed to adjust the various weights used by the LSTM, but the back propagation is significantly more complicated than that for the simpler recurrent neural-network nodes discussed with reference to FIG. 11A.

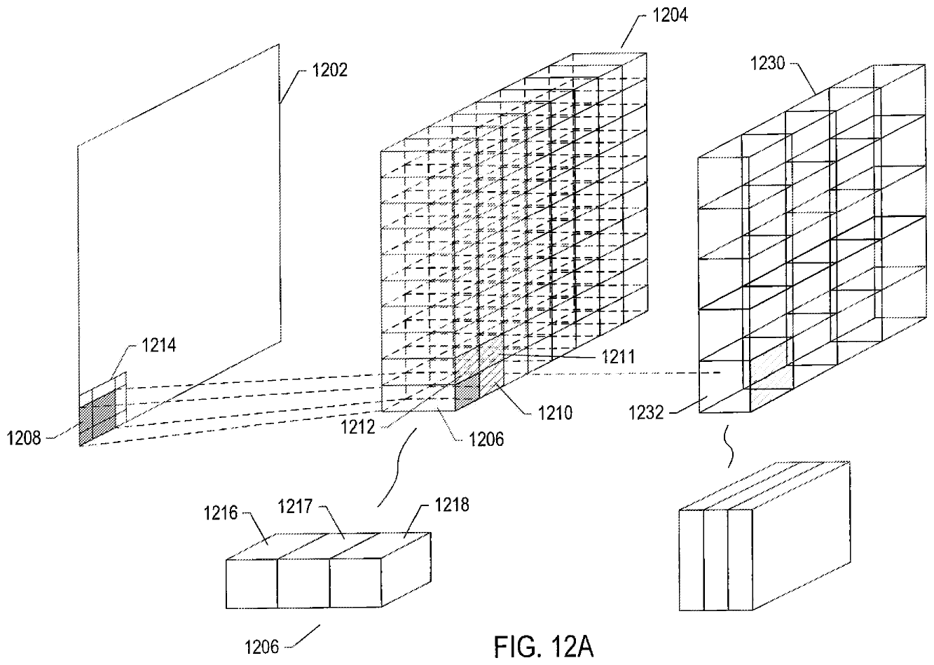

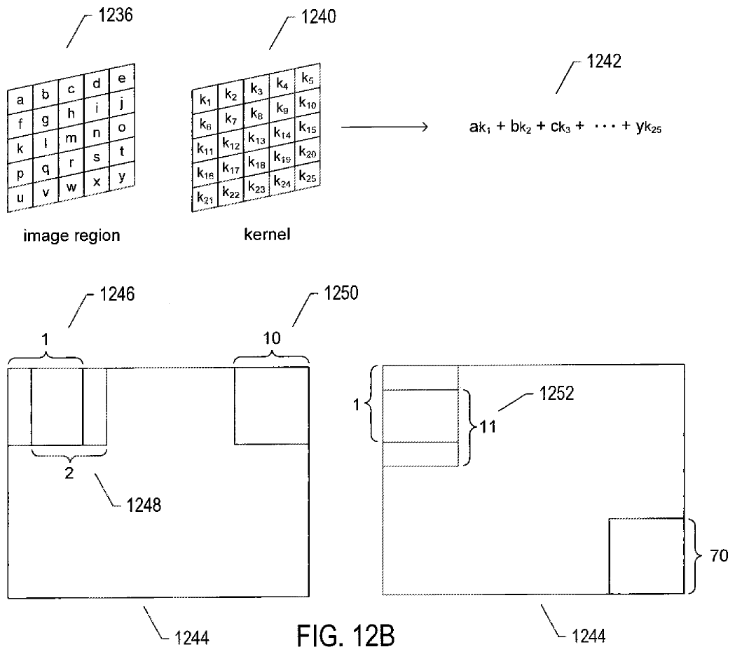

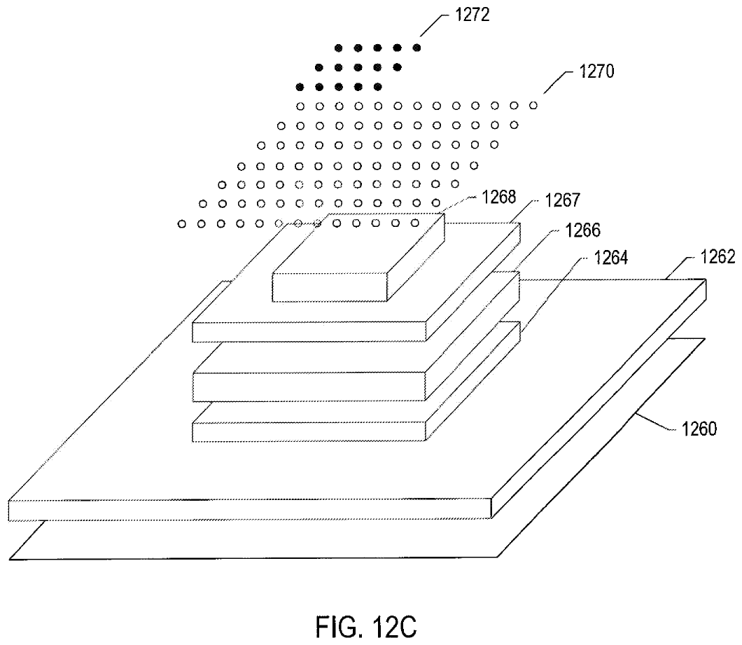

FIGS. 12A-C illustrate a convolutional neural network. Convolutional neural networks are currently used for image processing, voice recognition, and many other types of machine-learning tasks for which traditional neural networks are impractical. In FIG. 12A, a digitally encoded screen-capture image 1202 represents the input data for a convolutional neural network. A first level of convolutional-neural-network nodes 1204 each process a small subregion of the image. The subregions processed by adjacent nodes overlap. For example, the corner node 1206 processes the shaded subregion 1208 of the input image. The set of four nodes 1206 and 1210-1212 together process a larger subregion 1214 of the input image. Each node may include multiple subnodes. For example, as shown in FIG. 12A, node 1206 includes 3 subnodes 1216-1218. The subnodes within a node all process the same region of the input image, but each subnode may differently process that region to produce different output values. Each type of subnode in each node in the initial layer of nodes 1204 uses a common kernel or filter for subregion processing, as discussed further below. The values in the kernel or filter are the parameters, or weights, that are adjusted during training. However, since all the nodes in the initial layer use the same three subnode kernels or filters, the initial node layer is associated with only a comparatively small number of adjustable parameters. Furthermore, the processing associated with each kernel or filter is more or less translationally invariant, so that a particular feature recognized by a particular type of subnode kernel is recognized anywhere within the input image that the feature occurs. This type of organization mimics the organization of biological image-processing systems. A second layer of nodes 1230 may operate as aggregators, each producing an output value that represents the output of some function of the corresponding output values of multiple nodes in the first node layer 1204. For example, second-a layer node 1232 receives, as input, the output from four first-layer nodes 1206 and 1210-1212 and produces an aggregate output. As with the first-level nodes, the second-level nodes also contain subnodes, with each second-level subnode producing an aggregate output value from outputs of multiple corresponding first-level subnodes.

FIG. 12B illustrates the kernel-based or filter-based processing carried out by a convolutional neural network node. A small subregion of the input image 1236 is shown aligned with a kernel or filter 1240 of a subnode of a first-layer node that processes the image subregion. Each pixel or cell in the image subregion 1236 is associated with a pixel value. Each corresponding cell in the kernel is associated with a kernel value, or weight. The processing operation essentially amounts to computation of a dot product 1242 of the image subregion and the kernel, when both are viewed as vectors. As discussed with reference to FIG. 12A, the nodes of the first level process different, overlapping subregions of the input image, with these overlapping subregions essentially tiling the input image. For example, given an input image represented by rectangles 1244, a first node processes a first subregion 1246, a second node may process the overlapping, right-shifted subregion 1248, and successive nodes may process successively right-shifted subregions in the image up through a tenth subregion 1250. Then, a next down-shifted set of subregions, beginning with an eleventh subregion 1252, may be processed by a next row of nodes.

FIG. 12C illustrates the many possible layers within the convolutional neural network. The convolutional neural network may include an initial set of input nodes 1260, a first convolutional node layer 1262, such as the first layer of nodes 1204 shown in FIG. 12A, and aggregation layer 1264, in which each node processes the outputs for multiple nodes in the convolutional node layer 1262, and additional types of layers 1266-1268 that include additional convolutional, aggregation, and other types of layers. Eventually, the subnodes in a final intermediate layer 1268 are expanded into a node layer 1270 that forms the basis of a traditional, fully connected neural-network portion with multiple node levels of decreasing size that terminate with an output-node level 1272.

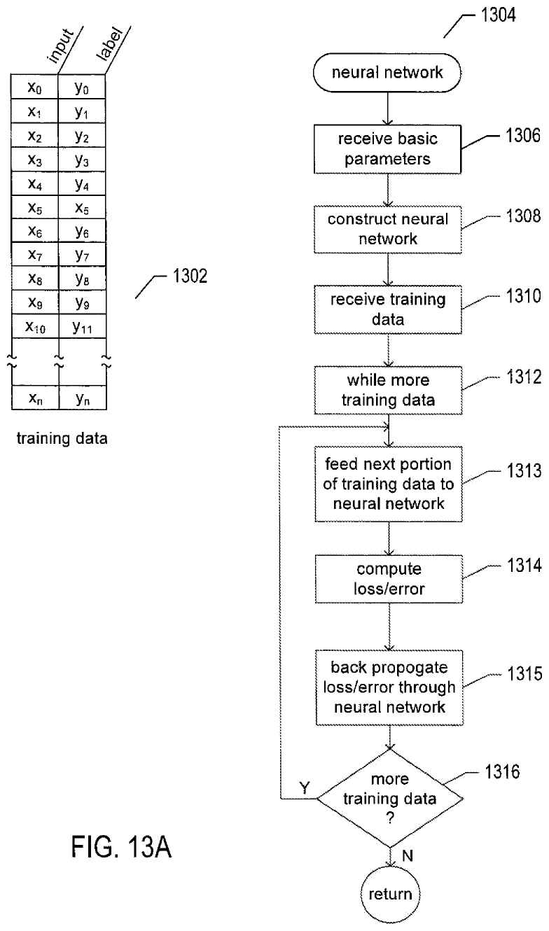

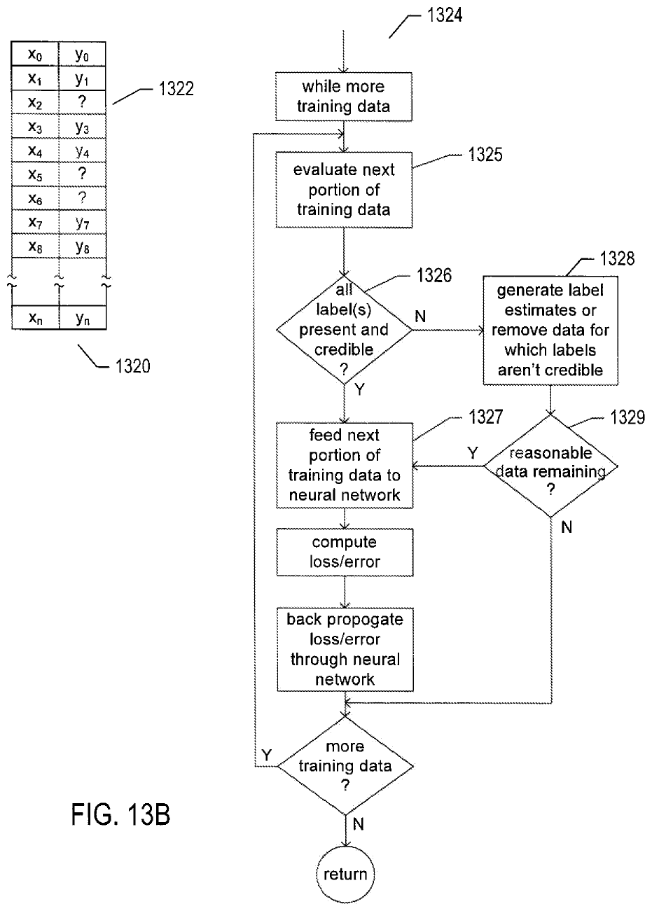

FIG. 13A-B illustrate neural-network training as an example of machine-learning-based-subsystem training. FIG. 13A illustrates the construction and training of a neural network using a complete and accurate training dataset. The training dataset is shown as a table of input-vector/label pairs 1302, in which each row represents an input-vector/label pair. The control-flow diagram 1304 illustrates construction and training of a neural network using the training dataset. In step 1306, basic parameters for the neural network are received, such as the number of layers, number of nodes in each layer, node interconnections, and activation functions. In step 1308, the specified neural network is constructed. This involves building representations of the nodes, node connections, activation functions, and other components of the neural network in one or more electronic memories and may involve, in certain cases, various types of code generation, resource allocation and scheduling, and other operations to produce a fully configured neural network that can receive input data and generate corresponding outputs. In many cases, for example, the neural network may be distributed among multiple computer systems and may employ dedicated communications and shared memory for propagation of activations and total error or loss between nodes. It should again be emphasized that a neural network is a physical system comprising one or more computer systems, communications subsystems, and often multiple instances of computer-instruction-implemented control components.

In step 1310, training data represented by table 1302 is received. Then, in the while-loop of steps 1312-1316, portions of the training data are iteratively input to the neural network, in step 1313, the loss or error is computed, in step 1314, and the computed loss or error is back-propagated through the neural network step 1315 to adjust the weights. The control-flow diagram refers to portions of the training data rather than individual input-vector/label pairs because, in certain cases, groups of input-vector/label pairs are processed together to generate a cumulative error that is back-propagated through the neural network. A portion may, of course, include only a single input-vector/label pair.

FIG. 13B illustrates one method of training a neural network using an incomplete training dataset. Table 1320 represents the incomplete training dataset. For certain of the input-vector/label pairs, the label is represented by a “?” symbol, such as in the input-vector/label pair 1322. The “?” symbol indicates that the correct value for the label is unavailable. This type of incomplete data set may arise from a variety of different factors, including inaccurate labeling by human annotators, various types of data loss incurred during collection, storage, and processing of training datasets, and other such factors. The control-flow diagram 1324 illustrates alterations in the while-loop of steps 1312-1316 in FIG. 13A that might be employed to train the neural network using the incomplete training dataset. In step 1325, a next portion of the training dataset is evaluated to determine the status of the labels in the next portion of the training data. When all of the labels are present and credible, as determined in step 1326, the next portion of the training dataset is input to the neural network, in step 1327, as in FIG. 13A. However, when certain labels are missing or lack credibility, as determined in step 1326, the input-vector/label pairs that include those labels are removed or altered to include better estimates of the label values, in step 1328. When there is reasonable training data remaining in the training-data portion following step 1328, as determined in step 1329, the remaining reasonable data is input to the neural network in step 1327. The remaining steps in the while-loop are equivalent to those in the control-flow diagram shown in FIG. 13A. Thus, in this approach, either suspect data is removed, or better labels are estimated, based on various criteria, for substitution for the suspect labels.

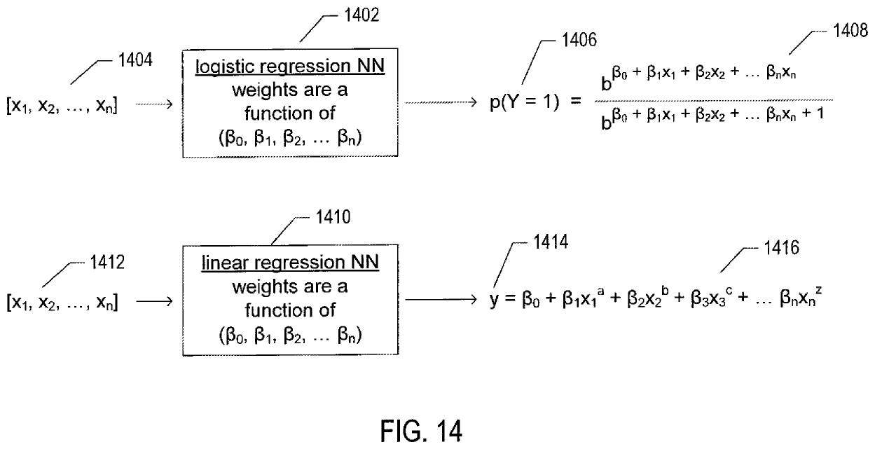

FIG. 14 illustrates two of many different types of neural networks. A neural network, as discussed above, is trained to implement a generally complex, non-linear function. The implemented function generally includes a multi-dimensional domain, or multiple input variables, and can produce either a single output value or a vector containing multiple output values. A logistic-regression neural network 1402 receives n input values 1404 and produces a single output value 1406 which is the probability that a binary variable Y has one of the two possible binary values “0” or “1,” which are often alternatively represented as “FALSE” and “TRUE.” In the example shown in FIG. 14, the logistic-regression neural network outputs the probability that the binary variable Y has the value “1” or “TRUE.” A logistic regression computes the value of the output variable from the values of the input variables according to expression 1408, and, therefore, a logistic-regression neural network can be thought of as being trained to learn the values of the coefficients β₀, β₁, β₂, . . . , βₙ. In other words, the weights associated with the nodes of a logistic-regression neural network are some function of the logic-regression-expression coefficients β₀, β₁, β₂, . . . , βₙ. Similarly, a linear-regression neural network 1410 receives n input values 1412 and produces a single real-valued output value 1414. A linear regression computes the output value according to the generalized expression 1416, and, therefore, a liner-regression neural network can again be thought of as being trained to learn the values of the coefficients β₀, β₁, β₂, . . . , βₙ. In traditional logistic regression and linear regression, any of various techniques, such as the least-squares technique, are employed to determine the values of the coefficients β₀, β₁, β₂, . . . , βₙ from a large set of experimentally obtained input-values/output-value pairs. The neural-network versions of logistic regression and linear regression learn a set of node weights from a training data set. The least-squares method, and other such minimization methods, involve matrix-inversion operations, which, for large number of input variables and large sets of input-values/output-value pairs, can be extremely computationally expensive. Neural networks have the advantage of incrementally learning optimal coefficient values as well as providing best-current estimates of the output values based on whatever training has already occurred.

### Reinforcement Learning

Neural networks are a commonly used and popular form of machine learning that have provided for spectacular advances in certain types of problem domains, including automated processing of digital images and automated natural-language-processing systems. However, there are many different additional types of machine-learning methods and approaches with particular utilities and advantages in various different problem domains. Reinforcement learning is a machine-learning approach that is increasingly used for various types of automated control. FIG. 15 provides an illustration of the general characteristics and operation of a reinforcement-learning control system. In FIG. 15, rectangles, such as rectangle 1502, represent the state of a system controlled by a reinforcement-learning agent at successive points in time. The agent 1504 is a controller and the environment 1506 is everything outside of the agent. As one example, an agent may be a management or control routine executing within a physical server computer that controls certain aspects of the state of the physical server computer. The agent controls the environment by issuing commands or actions to the environment. In the example shown in FIG. 15, at time t₀, the agent issues a command aₜ_{₀} to the environment, as indicated by arrow 1508. At time t₀, the environment responds to the action by implementing the action and then, at time t₁, returning to the agent the resulting state of the environment, sₜ_{ᵢ}, as represented by arrow 1510, and a reward, rₜ_{ᵢ}, as represented by arrow 1512. The state is a representation of the current state of the environment. For a server computer, for example, the state may be a very complex set of numeric values, including the total and available capacities of various types of memory and mass-storage devices, the available bandwidth and total bandwidth capacity of the processors and networking subsystem, indications of the types of resident applications and routines, the type of virtualization system, the different types of supported guest operating systems, and many other such characteristics and parameters. The reward is a real-valued quantity, often in the range [0, 1], output by the environment to indicate to the agent the quality or effectiveness of the just-implemented action, with higher values indicating greater quality or effectiveness. It is an important aspect of reinforcement-learning systems that the reward-generation mechanism cannot be controlled by the agent because, otherwise, the agent could maximize returned rewards by directly controlling the reword generator to return maximally-valued rewards. In the computer-system example, rewards might be generated by an independent reward-generation routine that evaluates the current state of the computer system and returns a reward corresponding to the estimated value of the current state of the computer system. The reward-generation routine can be developed in order to provide a generally arbitrary goal or direction to the agent which, over time, learns to issue optimal or near-optimal actions for any encountered state. Thus, in FIG. 15, following reception of the new state and reward, as indicated by arrows 1510 and 1512, the agent may modify an internal policy that maps actions to states based on the returned reward and then issues a new action, as represented by arrow 1514 according to the current policy and current state of the environment, sₜ_{₁}. A new state and reward are then returned, as represented by arrows 1516 and 1518, after which a next action is issued by the agent, as represented by arrow 1520. This process continues on into the future, as indicated by arrow 1522. In certain types of reinforcement learning, time is partitioned into epochs that each span multiple action/state-reward cycles, with policy updates occurring following the completion of each epoch, while, in other types of reinforcement learning, an agent updates its policy continuously, upon receiving each successive reward. One great advantage of a reinforcement-learning control system is that the agent can adapt to changing environmental conditions. For example, in the computer-system case, if the computer system is upgraded to include more memory and additional processors, the agent can learn, over time, following the upgrade of the computer system, to accept and schedule larger workloads to take advantage of the increased computer-system capabilities.

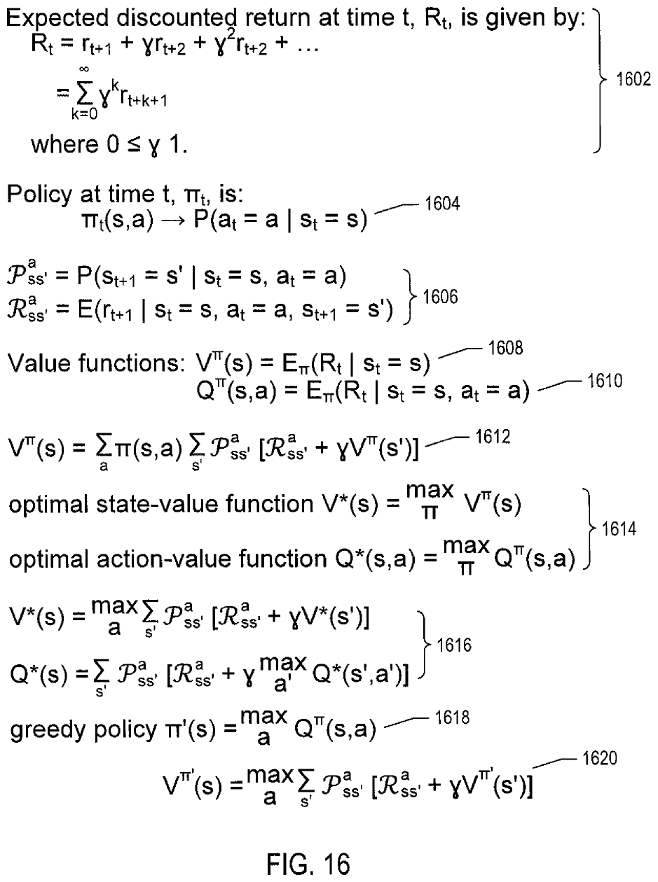

FIG. 16 illustrates certain details of one class of reinforcement-learning system. In this class of reinforcement-learning system, the values of states are based on an expected discounted return at each point in time, as represented by expressions 1602. The expected discounted return at time t. Rₜ, is the sum of the reward returned at time t+1 and increasingly discounted subsequent rewards, where the discount rate γ is a value in the range [0, 1). As indicated by expression 1604, the agent's policy at time t, πₜ, is a function that receives a state s and an action a and that returns the probability that the action issued by the agent at time t, aₜ, is equal to input action a given that the current state, sₜ, is equal to the input state s. Probabilistic policies are used to encourage an agent to continuously explore the state/action space rather than to always choose what is currently considered to be the optimal action for any particular state. It is by this type of exploration that an agent learns an optimal or near-optimal policy and is able to adjust to new environmental conditions, over time.

In many reinforcement-learning approaches, a Markov assumption is made with respect to the probabilities of state transitions and rewards. Expressions 1606 encompass the Markov assumption. The transition probability [symbol] is the estimated probability that if action a is issued by the agent when the current state is s, the environment will transition to state s′. According to the Markov assumption, this transition probability can be estimated based only on the current state, rather than on a more complex history of action/state-reward cycles. The value [symbol] is the expected reward entailed by issuing action a when the current state is s and [symbol] when the state transitions to state s′.

In the described reinforcement-learning implementation, the policy followed by the agent is based on value functions. These include the value function V^{π}(s), which returns the currently estimated expected discounted return under the policy π for the state s, as indicated by expression 1608, and the value function Q^{π}(s,a), which returns the currently estimated expected discounted return under the policy π for issuing action a when the current state is s, as indicated by expression 1610. Expression 1612 illustrates one approach to estimating the value function V^{π}(s) by summing probability-weighted estimates of the values of all possible state transitions for all possible actions from a current state s. The value estimates are based on the estimated immediate reward and a discounted value for the next state to which the environment transitions. Expressions 1614 indicate that the optimal state-value and action-value functions V*(s,a) and Q*(s,a) represent the maximum values for these respective functions given for any possible policy. The optimal state-value and action-value functions can be estimated as indicated by expressions 1616. These expressions are closely related to expression 1612, discussed above. Finally, an expression 1618 for a greedy policy π′ is provided, along with a state-value function for that policy, provided in expression 1620. The greedy policy selects the action that provides the greatest action-value-function return for a given policy and the state-value function for the greedy policy is the maximum value estimated for each of all possible actions by the sums of probability-weighted value estimations for all possible state transitions following issuance of the action. In practice, a modified greedy policy is used to permit a specified amount of exploration so that an agent can continue to learn while adhering to the modified greedy policy, as mentioned above.

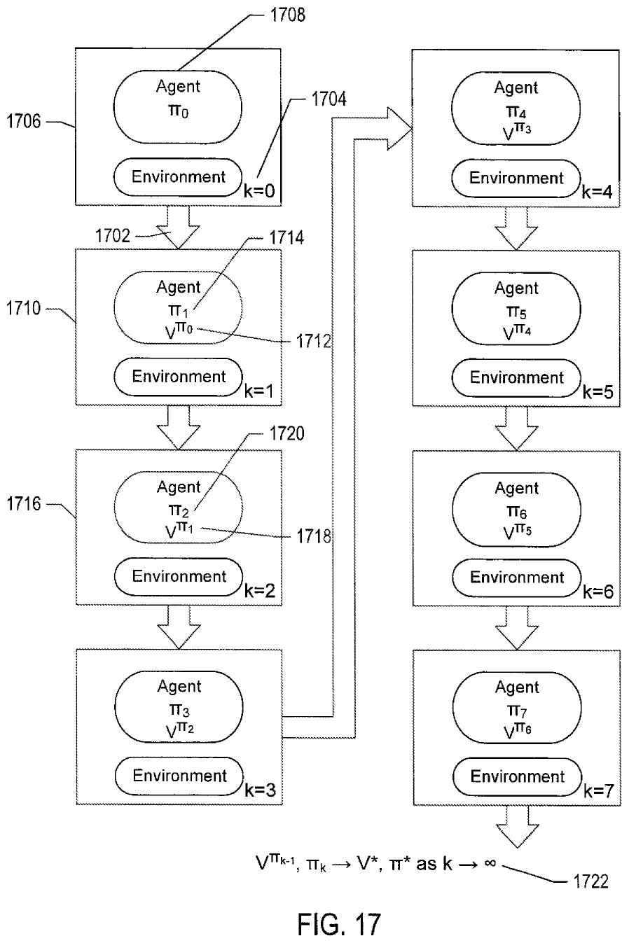

FIG. 17 illustrates learning of a near-optimal or optimal policy by a reinforcement-learning agent. FIG. 17 uses the same illustration conventions as used in FIG. 15, with the exceptions of using broad arrows, such as broad arrow 1702, rather than the thin arrows used in FIG. 15, and the inclusion of epoch indications, such as the indication “k=0” 1704. Thus, in FIG. 17, each rectangle, such as rectangle 1706, represents a reinforcement-learning system at each successive epoch, where epochs consist of one or more action/state-reward cycles. In the 0^{th} epoch, or first epoch, represented by rectangle 1706, the agent is currently using an initial policy π₀ 1708. During the next epoch, represented by rectangle 1710, the agent is able to estimate the state-value function for the initial policy 1712 and can now employ a new policy π₁ 1714 based on the state-value function estimated for the initial policy. An obvious choice for the new policy is the above-discussed greedy policy or a modified greedy policy based on the state-value function estimated for the initial policy. During the third epoch, represented by rectangle 1716, the agent has estimated a state-value function 1718 for previously used policy π₁ 1714 and is now using policy π₂ 1720 based on state-value function 1718. For each successive epoch, as shown in FIG. 15, a new state-value-function estimate for the previously used policy is determined and a new policy is employed based on that new state-value function. Under certain basic assumptions, it can be shown that, as the number of epochs approaches infinity, the current state-value function and policy approach an optimal state-value function and an optimal policy, as indicated by expression 1722 at the bottom of 17.

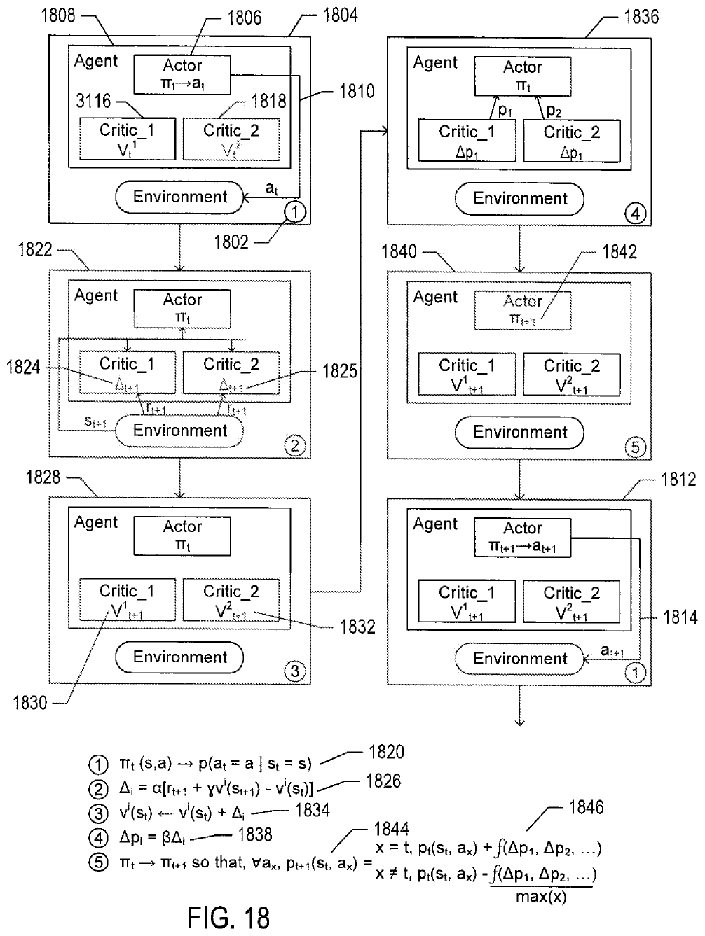

FIG. 18 illustrates one type of reinforcement-learning system the falls within a class of reinforcement-learning systems referred to as “actor-critic” systems. FIG. 18 uses similar illustration conventions as used in FIGS. 17 and 15. However, in the case of FIG. 18, the rectangles represent steps within an action/state-reward cycle. Each rectangle includes, in the lower right-hand corner, a circled number, such as circle “1” 1802 in rectangle 1804, which indicates the sequential step number. The first rectangle 1804 represents an initial step in which an actor 1806 within the agent 1808 issues an action at time t, as represented by arrow 1810. The final rectangle 1812 represents the initial step of a next action/state-reward cycle, in which the actor issues a next action at time t+1, as represented by arrow 1814. In the actor-critic system, the agent 1808 includes both an actor 1806 as well as one or more critics. In the actor-critic system illustrated in FIG. 18, the agent includes two critics 1860 and 1818. The actor maintains a current policy, πₜ, and the critics each maintain state-value functions Vₜⁱ where i is a numerical identifier for a critic. Thus, in contrast to the previously described general reinforcement-learning system, the agent is partitioned into a policy-managing actor and one or more state-value-function-maintaining critics. As shown by expression 1820, towards the bottom of FIG. 18, the actor selects a next action according to the current policy, as in the general reinforcement-learning systems discussed above. However, in a second step represented by rectangle 1822, the environment returns the next state to both the critics and the actor, but returns the next reward only to the critics. Each critic i then computes a state-value adjustment Δᵢ 1824-1825, as indicated by expression 1826. The adjustment is positive when the sum of the reward and discounted value of the next state is greater than the value of the current state and negative when the sum of the reward and discounted value of the next state is less than the value of the current state. The computed adjustments are then used, in the third step of the cycle, represented by rectangle 1828, to update the state-value functions 1830 and 1832, as indicated by expression 1834. The state value for the current state sₜ is adjusted using the computed adjustment factor. In a fourth step, represented by rectangle 1836, the critics each compute a policy adjustment factor Δₚ, as indicated by expression 1838, and forward the policy adjustment factors to the actor. The policy adjustment factor is computed from the state-value adjustment factor via a multiplying coefficient β, or proportionality factor. In step 5, represented by rectangle 1840, the actor uses the policy adjustment factors to determine a new, improved policy 1842, as indicated by expression 1844. The policy is adjusted so that the probability of selecting action a when in state sₜ is adjusted by adding some function of the policy adjustment factors 1846 to the probability while the probabilities of selecting other actions when in state sₜ are adjusted by subtracting the function of the policy adjustment factors divided by the total number of possible actions that can be taken at state sₜ from the probabilities.

### Minimax Optimal Decisions

FIGS. 19A-B illustrate a generalized deterministic, two-player, zero-sum game of perfect information used to illustrate the minimax adversarial search method. As shown by the gameboard 1902 in FIG. 19A, a board game, like chess or checkers, is one example of a deterministic, two-player, zero-sum game of perfect information. One of the players is referred to as “Max” 1903 and the other player is referred to as “Min” 1904. This example game is defined by a number of functions and variables shown by a set of expressions 1905 in the top portion of FIG. 19A. The state variable s for the game 1906 contains a representation of the current game state, including the current positions of all pieces on the gameboard for both players. The function P(s) 1907 takes the current state s as an argument and returns an indication p of the player who needs to make the next play. The function A(s) 1908 takes the current state s as an argument and returns a set of actions from which the next play can be chosen. The function Play(a,s) 1909 takes an action a and the current state s as arguments and returns a new value of the state variable, s′, that results from taking action a by the player P(s) when the current state of the game is s. The function T(s) 1910 takes the current state s as an argument and returns a Boolean indication of whether the current state is a terminal game state, such as a state following a last move resulting in a win for one of the two players or a last move resulting in a tied or drawn game. The function O(s) 1911 takes the current state s as an argument and returns a scalar value V_{s,p}_{₁} representing the value of the state to player Max, also referred to as player “p₁.” Only a terminal state is associated with a scalar value for Max. This value is generally a real number in the range [0,1], with the value of a state representing a loss by Max equal to 0 and the value of the state representing a win by Max equal to 1. Other mappings of numerical values to states are, of course, possible.

The minimax adversarial search method allows a player, at any given non-terminal state of a deterministic, two-player, zero-sum game of perfect information, to select an optimal next move or, in other words, to make a minimax optimal decision. The minimax adversarial search method recursively assigns a minimax value to each node in a game tree that represents all possible games that can be played. The game tree includes a root node 1920 representing an initial game state s₀ 1921 for which the next move belongs to the player Max 1922. Each non-terminal node representing a state, such as state sₓ, contains links, or edges, leading to lower-level nodes representing states that result from carrying out each of the various actions available to the player who moves next when the game is in state sₓ. Thus, for example, if the player Max makes a move corresponding to action a₁ from state s₀, the resulting game state is represented by node 1923 connected to the root node 1920 by an edge 1924 labeled a₁.

Each node in the game tree is associated with a minimax value, expressed as “minimax (sₓ).” for a node representing state sₓ. The minimax value is the value of the state sₓ to the player P(sₓ) or, in other words, to the player who next moves when the game is in state sₓ. Of course, when selecting a next move, the player Min would wish to choose an action a selected from A(s_{y}), where P(s_{y})=p₂, that leads to a next state with the lowest possible value for the player Max, while the player Max would wish to select an action a selected from A(sₓ), where P(sₓ)=p₁, that leads to a state with the highest possible value for the player Max. Consider, for example, node 1926. This node represents a state s_{d} for which the next move belongs to player Max. Because the player Max wishes to choose a play that results in a state of maximum value to the player Max, the minimax value for node s_{d}, minimax (s_{d}), is equal to the maximum minimax value associated with any of the child nodes of node 1926. One of these child nodes, node 1928, represents state sₑ, which is a terminal state with a scalar value Vₛ_{ₑ}_{,p}_{₁} equal to U, as indicated by expressions 1930. If, in fact, the minimax value of terminal node 1928 is the maximum value of any of the child nodes of node 1926, then the minimax value of node 1926, minimax (s_{d}), is equal to U. Otherwise, the minimax value of node 1926 would be equal to a higher minimax value or scalar value of another of the child nodes of node 1926. Thus, terminal nodes represent local endpoints of recursive depth-first searches starting from a particular node in the game tree and descending to all possible terminal modes that can be reached from that starting-point node. Next, consider node 1932. This node represents a state s_{c} for which the next move belongs to player Min. Because the player Min wishes to choose a play that results in a state of minimum value to the player Max, the minimax value for node s_{c}, minimax(s_{c}), is equal to the minimum minimax value associated with any of the child nodes of node 1932. One of these child nodes, node 1926, represents state s_{d}. If the minimax value associated with node 1926 has the lowest minimax value of all child nodes of node 1932, then the minimax value of node 1932 would be set to the minimax value of node 1926. Otherwise, the minimax value of node 1932 would be equal to the lower minimax value or scalar value of another of the child nodes of node 1932. In the case that the minimax value of node 1926 has the lowest minimax value of any of the child nodes of node 1932, and if the value associated with terminal node 1928 has the highest value associated with any of the child nodes of 1926, the minimax value of node 1932 would be U. As can be seen in FIG. 19B, the minimax value associated with a node alternates between a maximum of the values of the child nodes and a minimum of the values of the child nodes as one ascends the game tree from lower nodes to higher nodes. The minimax value associated with any node in the game tree is equal to the scalar value associated with one of the terminal nodes. The alternating pattern of maximum and minimum minimax values represents the adversarial nature of the decision process. Max and Min have essentially opposite goals and the minimax optimal decision is a product of both players continuously seeking to achieve their goals. This same pattern of concurrent adversarial, goal-directed activities will be observed in the additional types of adversarial-optimization methods, discussed below.

The minimax value minimax(sₓ) associated with a game-tree node representing state sₓ is thus obtained by a recursive depth-first search of the game tree beginning with the minimax node representing state sₓ, as indicated by expression 1936 in the lower portion of FIG. 19B. When the node representing state sₓ is a terminal node, then the minimax value of the node representing state sₓ is the scalar value associated with the node. O(sₓ). Otherwise, if Max is to move at state sₓ, the minimax value of the node representing state sₓ is the maximum minimax value or scalar of any child nodes of the node representing state sₓ. Otherwise, when it is Min's turn to move at state sₓ, the minimax value of the node representing state sₓ is the minimum minimax value or scalar value of any child node of the node representing state sₓ.

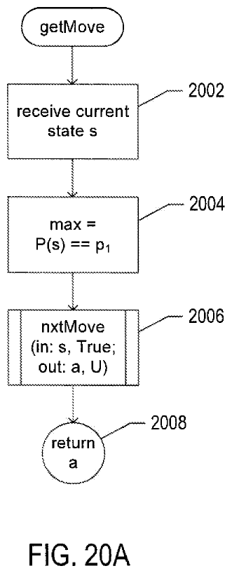

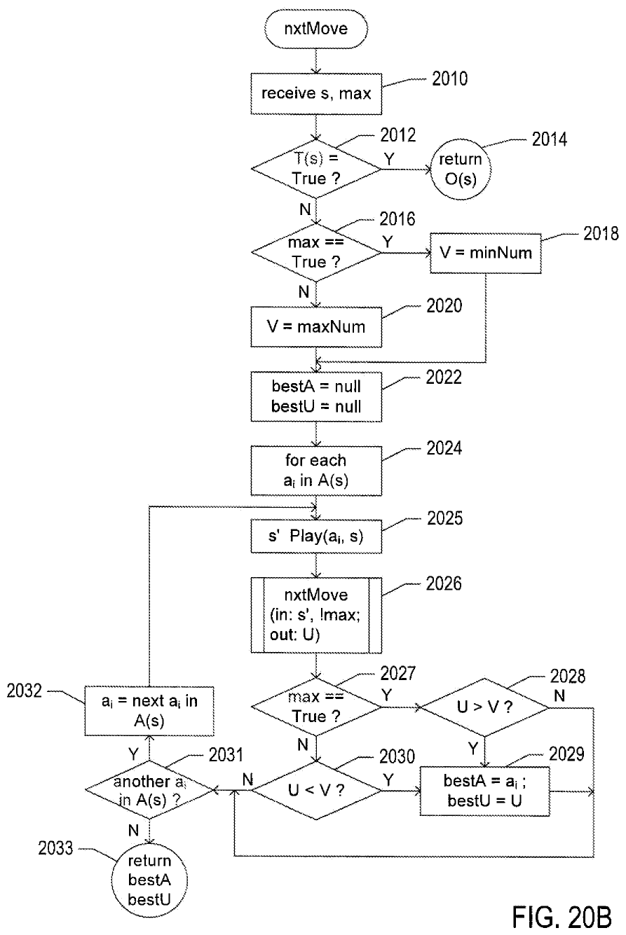

FIGS. 20A-B provide control-flow diagrams that illustrate the minimax-optimal-decision method. The routine “getMove,” shown in FIG. 20A, receives a current game state s and returns the optimal action a, also referred to as the “optimal play” or “optimal move.” In step 2002, the input state s is received. In step 2004, the routine “getMove” sets a local Boolean variable may to indicate whether the player Max is to move. In step 2006, the routine “getMove” calls a routine “nxtMove” to carry out a recursive adversarial search to find the optimal next action. Finally, in step 2008, the routine “getMove” returns the action a returned by the routine “nxtMove.”

FIG. 20 B provides a control-flow diagram for the routine “nxtMove,” called in step 2006 of FIG. 20A. In step 2010, the routine “nxtMove” receives a current state s and the Boolean variable max. When the current state is a terminal state, as determined in step 2012, the routine “nxtMove” returns the scalar value of the terminal state, in step 2014. Otherwise, when the input variable mar is True, as determined in step 2016, local variable v is set to some minimum representable numerical value, in step 2018, and when the input variable max is False, local variable v is set to some maximum representable numerical value, in step 2020. In step 2022, the routine “nxtMove” sets local variable bestA and local variable bestU to null values. In the for-loop of steps 2024-2032, the routine “nxtMove” considers each possible action a₁ in the set of actions A(s). In step 2025, the routine “nxtMove” generates the next state s′ obtained by playing or taking action aᵢ when the game is in state s. In step 2026, the routine “nxtMove” calls itself recursively with arguments s′ and the Boolean inverse of the current value of the variable mar. When the value of the received variable max is True, as determined in step 2027, and when the value U returned by the recursive call to the routine “nxtMove” is greater than the value contained in local variable v, as determined in step 2028, or when the value of the received variable mar is False and when the value U returned by the recursive call to the routine “nxtMove” is less than the value contained in local variable v, as determined in step 2030, the routine “nxtMove” sets local variable bestA to aᵢ and local variable bestU to the value U returned by the recursive call to the routine “nxtMove.” in step 2029. When there is another aᵢ in the set of actions A(s) to consider, as determined in step 2031, aᵢ is set to the next action in the set of actions A(s), instep 2032, and control returns to step 2025 for a next iteration of the for-loop of steps 2024-2032. Otherwise, the routine “nxtMove” returns the current values of local variable bestA and bestU, in step 2033.

The above-described minimax method is, of course, not practical for many real-life games, such as chess, because the game tree for such games is far too large to exhaustively search. For simpler games, at later stages of complex games, and in other problem domains, the minimax method can actually provide optimal selections of actions. Action selection is optimal in the sense that the minimax action represents the optimal action that can be taken assuming that both Max and the Min play optimally from the current state of the game to the end of the game.

### Generative Adversarial Networks

Generative adversarial networks are examples of a minimax-type of optimization method used to train machine-learning entities. In the discussion, below, an example of a generative adversarial networks is described for training a discriminator neural network to discriminate between actual data values, such as images, and fake, or synthetic, images generated by a generator neural network while at the same time training the generator neural network to produce convincing fake, or synthetic, images. The adversarial competition between the discriminator and the generator results in a trained generator that can provide convincing synthetic images. Practical implementations of this generative adversarial network has produced automated image-generation programs that can be used to produce synthetic photographs that appear to be authentic to human observers. These automated image-generation programs have a variety of legitimate uses, but can also be used for producing convincing forgeries.

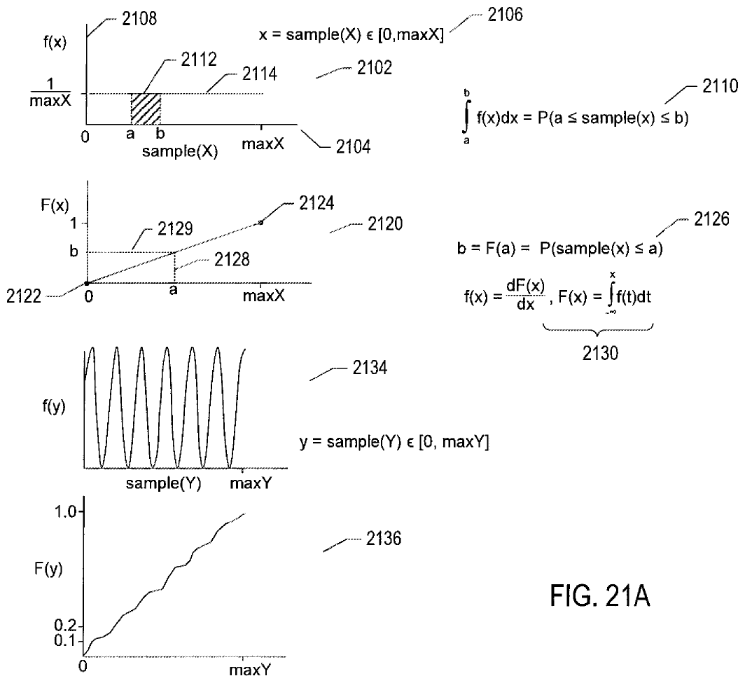

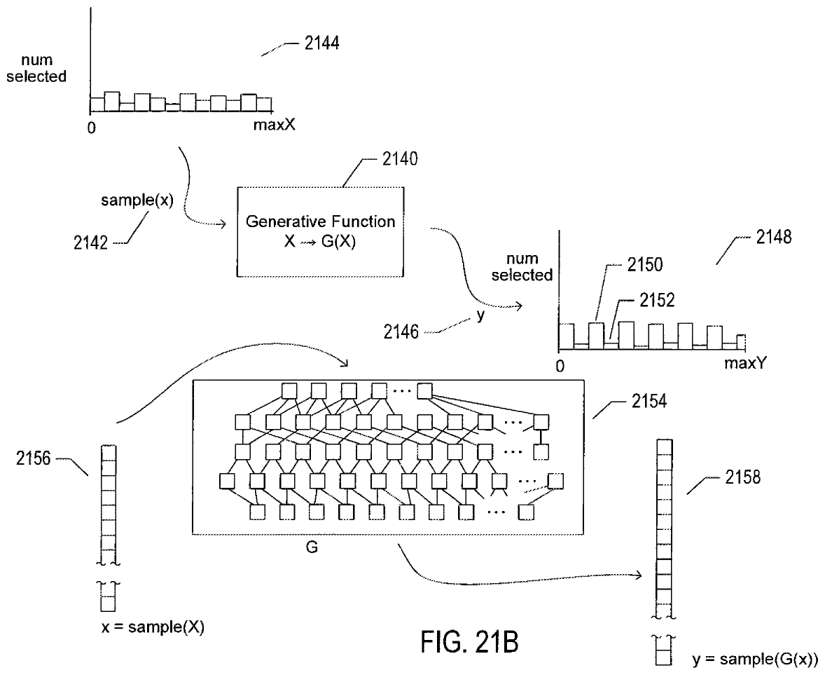

FIGS. 21A-B illustrate a generative function. FIG. 21A shows a probability density function and cumulative probability distribution function for a uniform random variable X and a probability density function and cumulative probability distribution function for a non-uniform random variable Y. Plot 2102 is a plot of a probability density function ƒ(x) for a uniform random variable X. The horizontal axis 2104 represents the possible values of samples x of the uniform random variable X, as indicated by expression 2106, which fall in the range [0, maxX] and the vertical axis 2108 represents a probability in the range [0, 1]. As indicated by expression 2110, the probability that a value x, obtained by sampling the random variable X, is between constant values a and b is equal to the area 2112 below the probability-density-function curve 2114 between values a and b. For a uniformly distributed random variable, the probability-density-function curve 2114 is a straight horizontal line at the height 1/maxX between 0 and maxX, and is everywhere else 0. Thus, the total area below the probability-density-function curve 2114 is (1/maxX)*maxX=1, meaning that the value of a sample x is between 0 and maxX with a probability of 1.0, equivalent to certainty. Plot 2120 is a plot of the cumulative distribution function F(x) for the uniform random variable X. The cumulative distribution function F(x) is a straight line from the point (0,0) 2122 to the point (maxX, 1) 2124. For a particular value a in the range [0, maxX], the probability that a sample of the random variable X will have a value in the range [0, a] is F(a), as indicated by expression 2126 and dashed lines 2128-2129. The probability density function and cumulative probability distribution functions are related as indicated by expressions 2130, with the probability density function obtained as the derivative of the cumulative probability distribution function and the cumulative distribution function obtained by integrating the probability density function. Plot 2134 is a plot of probability density function ƒ(y) for a different, non-uniformly distributed random variable Y and plot 2136 is the cumulative distribution function for the non-uniformly distributed random variable Y.

There are well-known computational and physical methods for generating a sequence of samples x that appear to represent samples of a uniformly distributed random variable X. These include computational pseudo-random number generators and samplings of random noise, such as static noise generated by various types of electrical circuitry. A generative function receives samples x of a uniformly distributed random variable and produces corresponding values y consistent with sampling from a non-uniformly distributed random variable Y. A generative function is illustrated, in the upper portion of FIG. 21B, as rectangle 2140 which receives a sample 2142 from uniformly distributed random variable X 2144 and produces an output y 2146 that appears to have been sampled from a non-uniformly distributed random variable Y 2148. In this illustration, all of the columns in the probability density function for the uniformly distributed random variable 2144 are not of equal height to represent the fact that, for any finite set of samples, there is an associated variance with respect to the ideal probability density function. Thus, the generative function 2140 transforms a noise value into a different value that appears to have been sampled from a non-uniformly distributed random variable. In the example of FIGS. 21A-B, the taller columns, such as column 2150, in the probability-density-function plot 2148 represent ranges of values that will be most frequently generated by the generative function and the valleys between these taller columns, such as valley 2152, represent ranges of values that will be infrequently generated by the generative function. As one example, a neural network 2154 can be trained to simulate a generative function to which vector samples x 2156 of a uniformly-distributed random vector variable X are input and from which vector values y 2158 of a non-uniformly distributed random vector variable Y are output. As one example, the input vector samples may be generated by a pseudo-random computational process and the output vectors may be synthetic images that appear to be actual photographs to human observers, and the series of outputs may appear to have been randomly sampled from set of synthetic-image vectors within a vector space. As discussed in preceding sections of this document, neural networks can be computationally constructed and trained to simulate arbitrary complex functions, so it is unsurprising that neural networks can be constructed and trained to simulate generative functions.

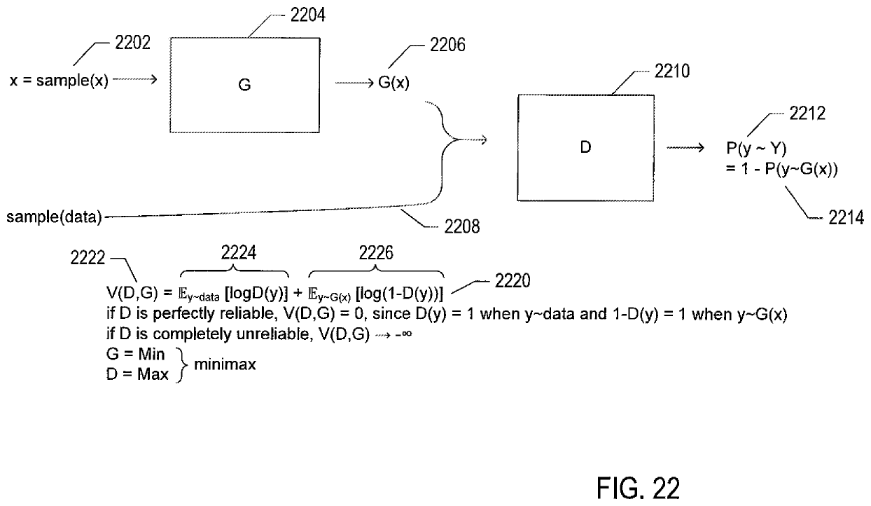

FIG. 22 provides an illustration of the generative-adversarial-network method for simultaneously training a generator G, which simulates a generative function, and a discriminator D, which produces a probability value in the range [0, 1]. During mutual training of the generator and the discriminator, samples x 2202 of a uniformly distributed random vector variable X are input to the generator 2204, which produces output synthetic-image vectors G(x) 2206 that, over the course of training, appear more and more similar to actual photographs. In addition, another set of vectors 2208 are obtained from a set of photographs. The sets of synthetic-image vectors G(x) 2206 and data vectors 2208 are combined to generate a training dataset, each vector y of which is input to the discriminator 2210, which outputs, for each input vector y, a probability 2212 that the input vector y is sampled from the set of data vectors. This probability is equal to 1 minus a probability 2214 that the input vector y is sampled from the set of synthetic-image vectors G(x).

As shown in FIG. 22 by expression 2220, a minimax objective value V(D,G) 2222 can be associated with the current training state of the generator G and the current training state of the discriminator D. The minimax value V(D,G) is computed as the sum of two terms 2224 and 2226. The first term 2224 is the expectation value of the logarithm of the probability value returned by the discriminator for an input vector y, D(y), when y sampled from a set of vectors distributed according to the distribution of data vectors. When the discriminator is perfectly reliable, this term should have the value 0, since the logarithm of 1 is 0 and since D(y)=1.0 for a perfectly reliable discriminator and a data vector y. The second term 2226 is the expectation value for the logarithm of 1−D(y) when y selected from a set of vectors distributed according to the distribution of vector values G(x) output by the generator G. Since a perfectly reliable discriminator produces the probability value 0 for vector values y selected from a set of vectors distributed according to the distribution of vector values G(x), the logarithm of 1−D(y) for y selected from the distribution of vector values G(x) would be expected to be 0 for the perfectly reliable discriminator. For a faulty or unreliable discriminator, both terms 2224 and 2226 have negative values and as the discriminator approaches complete unreliability, V(D, G) approaches negative infinity. Thus in a minimax-based training method to train the generator and the discriminator, the generator is trained with the goal of minimizing the objective value V(D, G) and the discriminator is trained with the goal of maximizing the objective value V(D, G). The generator can minimize the objective value V(D, G) by producing output vectors G(x) that appear to have been selected from a distribution of vector values equivalent to that of the data vectors. In the image example, the generator minimizes the objective value V(D, G) by producing synthetic images that cannot be differentiated, by the discriminator, from actual photographs. The discriminator maximizes the objective value V(D, G) by accurately differentiating synthetic vectors produced by the generator from sample data or, in other words, in the image example, by accurately differentiating actual photographs from synthetic photographs produced by the generator.

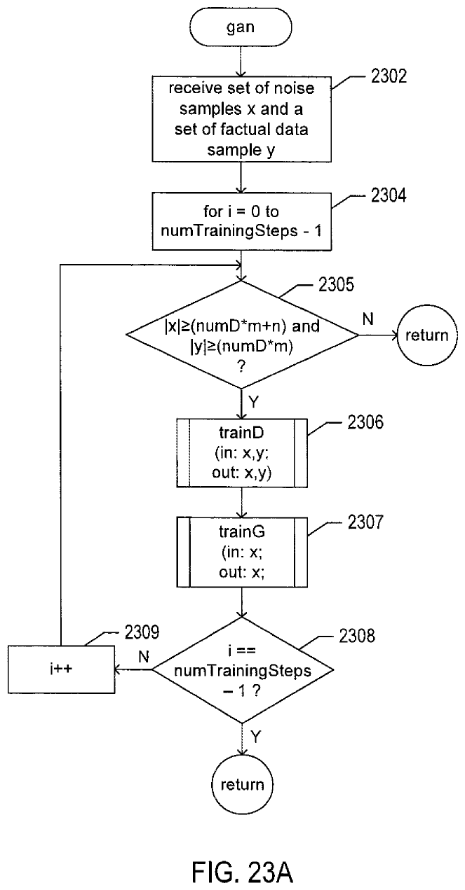

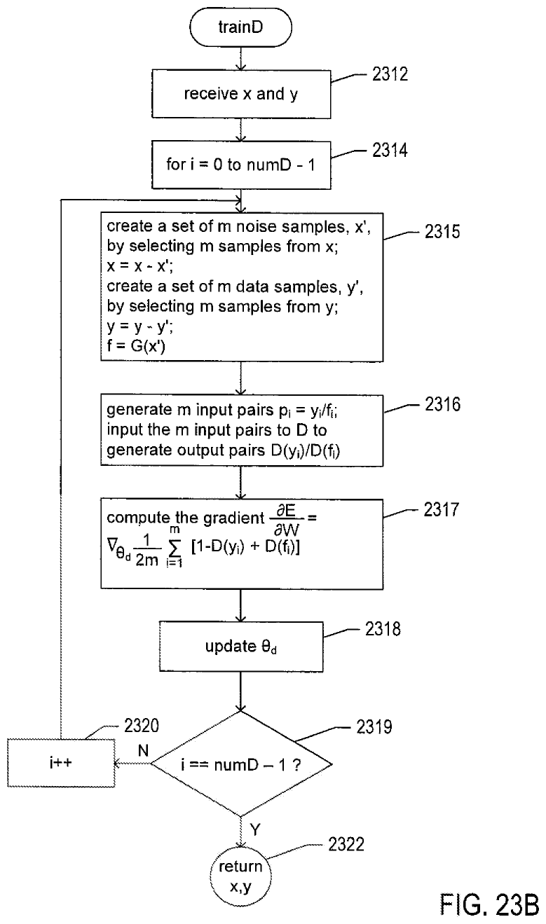

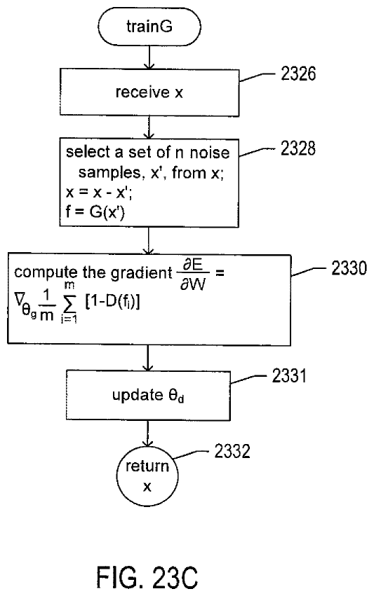

FIGS. 23A-C illustrate a generative-adversarial-network method for concurrently training a generator neural network G and a discriminator neural network D. FIG. 23A provides a control-flow diagram for the routine “gan,” an acronym for “generative adversarial network.” In step 2302, the routine “gan” receives a set of noise samples x, or random samples of a uniformly distributed vector variable X, and a data set containing vectors y obtained from some data source. Then, in the for-loop of steps 2304-2309, a number of training steps equal to a constant numTrainingSteps is carried out, when the received sample set and data set have sufficient sizes. When the sizes of either or both of the samples set and data set are insufficient for a next training step, as determined in step 2305, the routine “gan” terminates. Otherwise, a routine “trainD” is called, in step 2306, to carry out a next training step for the discriminator D, and, in step 2307, a routine “trainG” is called to carry out a next training step for the generator. When there are more training steps to carry out, as determined in step 2308, the loop variable i is incremented, in step 2309, and control returns to step 2305 for another iteration of the for-loop of steps 2304-2309. Otherwise, the routine “gan” successfully terminates, having completed the full number of training steps to train both the discriminator D and the generator G.

FIG. 23B provides a control-flow diagram for the routine “trainD,” called in step 2306 of FIG. 23A. In step 2312, the routine “trainD” receives noise samples x and data samples y. Then, in the for-loop of steps 2314-2320, the routine “trainD” carries out numD training batches. In step 2315, the routine “trainD” creates a set of m noise samples x′ by removing the m noise samples from received set of noise samples x and creates a set of m data samples y′ by removing the set of m data samples from the received set of data samples y, and then creates a set of generated samples ƒ from the set of m noise samples x′. In step 2316, the routine “trainD” generates m input pairs each containing a data sample selected from y′ and a generated sample selected from ƒ. Each sample of each of the input pairs is submitted to the discriminator to generate an output pair of discriminator outputs. In step 2317, the routine “trainD” computes the gradient, with respect to the weight associated with the neural network nodes, for the sum

$$\frac{1}{2 m} {\sum }_{i = 1}^{m} [ 1 - D ( {y}_{i} ) + D ( {f}_{i} ) ]$$

and uses the gradient, in step 2318, to update the discriminator's neural-network-node weights, or parameters. When there is another training batch to carry out, as determined in step 2319, the loop variable i is incremented, in step 2320, and control then flows back to step 2315 for another iteration of the for-loop of steps 2314-2320. Otherwise, the routine “trainD” returns the current noise data sets x and y, in step 2322.

FIG. 23C provides a control-flow diagram for the routine “trainG,” called in step 2306 of FIG. 23A. In step 2226, the routine “trainG” receives noise samples x. Then, in step 2228, the routine “trainG” selects a set of n noise samples, x′, from the set of received noise samples x, removing the selected noise samples from the set of received noise samples x and inputs the selected noise samples to the generator to generate a corresponding set of output vectors ƒ. In step 2230, the routine “trainG” computes the gradient, with respect to the weight associated with the neural network nodes of G, for the sum

$$\frac{1}{m} {\sum }_{i = 1}^{m} [ 1 - D ( {f}_{i} ) ]$$

and uses the gradient, in step 2331, to update the generator's neural-network-node weights, or parameters. The routine “trainG” returns the current set of noise samples x, in step 2232.

### Currently Disclosed Methods and Systems

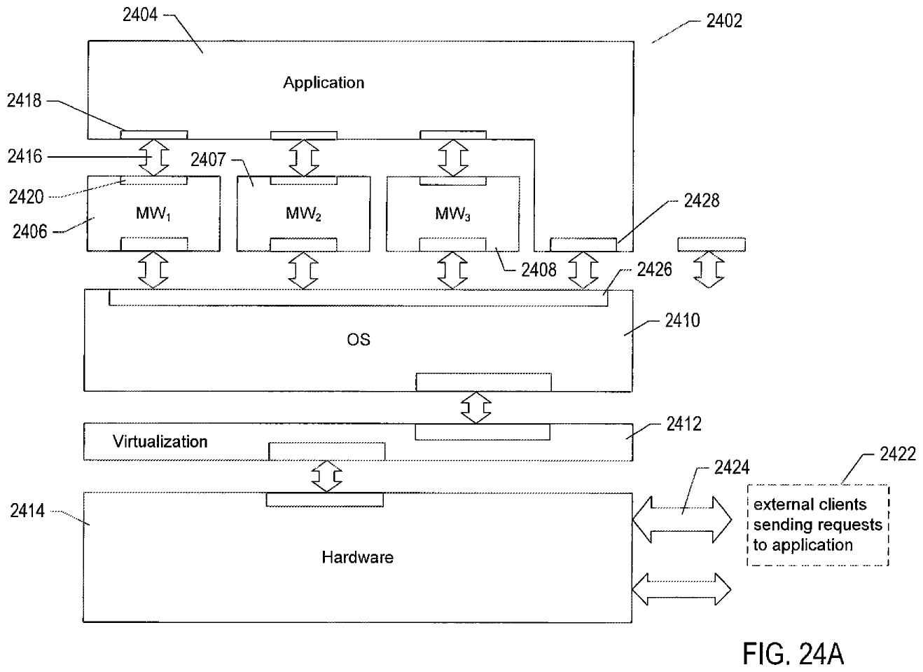

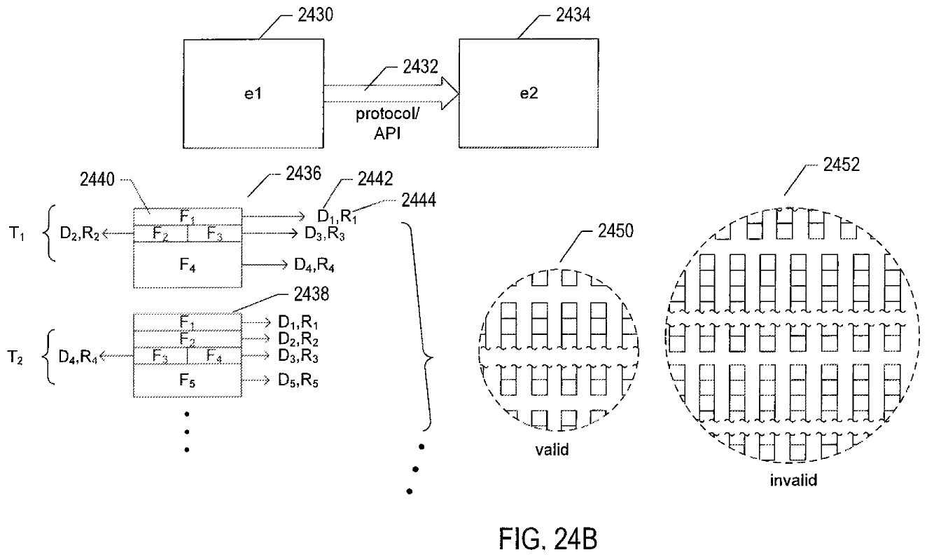

FIGS. 24A-B illustrates a problem domain used as an example of an application of the currently disclosed methods and systems. FIG. 24A shows various components of a discrete computer system 2402. These include: an application 2404; various middleware components 2406-2408, such as database management systems, portals to on-line information-providing systems, shared-memory-based message services, and other middleware components; an operating system 2410; a virtualization layer 2412; and a hardware layer 2414 containing many different hardware components, as discussed in preceding sections of this document. Of course, the problem domain may include many different discrete computer systems along with many instances of each of multiple distributed applications. In general, each of the components, such as the application 2404, may communicate with other components and external entities. Communications between components are indicated, in FIG. 24A, by double-headed arrows, such as double-headed arrow 2416. In general, these communications involve interfaces, such as interfaces 2418 and 2420 in the communicating components. These communications may involve network communications, remote procedure calls, system calls, and various other types of communications and combinations of different types of communications. For example, one type of communication involves requests made by external clients 2422 to services provided by the application via an application service interface, such as a RESTful (“Representational State Transfer”) service interface. In this case, the requests are transferred via network communications 2424 to communications hardware in the hardware layer 2414, such as a network interface card (“NIC”), through interfaces between the hardware layer 2414 and virtualization layer 2412 and between the virtualization layer 2412 and operating system 2410 and, ultimately, through an operating-system interface 2426 to a corresponding interface 2428 employed by the application program to receive network messages, which are then translated as requests to application-program-provided services provided through an application services interface. In this document, the phrase “communication link” is used to generally refer to any of the many possible mechanisms by which two different computational entities can exchange data, mentioned above. All of these different types of communications between different components of one or more computer systems represent vulnerabilities to attack by malicious entities as well as potential sources of inadvertent secure-data leaks. The nature of the actual communications and communication interfaces varies widely, and specific details are beyond the scope of the current document. For example, the virtualization layer 2412 can be instrumented to monitor communications between the virtualization layer and guest operating systems, and most commercially available virtualization layers collect and maintain information and derive statistics from such monitoring activities. The virtualization layer can easily intercept communications of various different types, including system-call-like communications between guest operating systems and the virtualization layer. Operating systems and, of course, monitor system calls made to, and processed by, the operating systems, and also can include communications-monitoring functionalities that intercept system calls made to the operating systems by application-layer entities. Application layers can also include similar instrumentation. However, the exact mechanisms used for monitoring the various types of communications are highly dependent on the implementations of the virtualization layers, operating system and application-level programs.

There is a need for monitoring inter-component communications within computer systems, such as requests directed from a first component to a second component that represent requests for data responses, requests for performance of actions by the second component, and many other types of requests, in order to detect potentially harmful communications. A communications-monitoring entity would need to intercept to communications between pairs of components and/or between internal components and external entities, detect potentially harmful requests, and ameliorate the potential harm. Because of the wide variation in communications methods and interfaces, a variety of different types of approaches are needed to intercept communications between any given pair of computer-system components. There are, of course, existing examples of communications monitors, such as firewalls built into edge routers and other communications hardware. However, these existing communication monitors are often rule-based and relatively static in their operational behaviors. They are, in a sense, more reactive than intelligent, being configured to respond to known, anticipated types of threats, such as repeated attempts by an external entity to guess a password, denial-of-service attacks, redirection of responses to malicious external entities, and other such threats. The existing communications monitors are generally not capable of identifying and ameliorating new types of threats.

FIG. 24B illustrates transmission of a request from a first component to a second component. The first source component e₁ 2430 sends the request, defined by a particular application programming interface (“API”) or service interface, by a particular type of communications medium and protocol 2432, to a target component e₂ 2434. In general, a request is a formatted set of one or more data fields corresponding to a message or request template. In the lower portion of FIG. 24B, examples of request templates T₁ 2436 and T₂ 2438 are shown. Each field in a template, such as the first field 2440 in template 2436, is associated with a data type, such as data type 2442 associated with field 2440. In addition, a field may be associated with a range of values, such as range 2444 for field 2440. A request can be considered to be a vector of data values, with each element of the vector representing a field and containing a value representing the value of the particular data type for the field within a range or set of values allowed for the field. Thus, a request transmitted between components e₁ and e₂ can be considered to be a vector of numeric values that is a point or vector instance within a very large vector space that includes all possible vectors. The vector space can be divided into a set of vectors corresponding to valid requests 2450 and a generally much larger set of vectors corresponding to invalid requests 2452. The vectors in the set of valid requests 2450 have numerical values, or elements, that each corresponds to numerical values associated with the data type specified for the element and within a specified range of values for the element. The vectors in the set of invalid requests 2452 include one or more numerical values that violate the data-type and range constraints. The invalid requests, or invalid vectors from the set of invalid vectors 2452, are immediately rejected by the receiving component and therefore are not potentially harmful. Thus, the set of valid vectors 2450 contains vectors corresponding to legitimate requests that tend to be harmless, legitimate requests that may, in fact, be potentially harmful, illegitimate requests input to the target component by malicious entities that maybe nonetheless harmless, and illegitimate requests input to the target component that are potentially harmful.

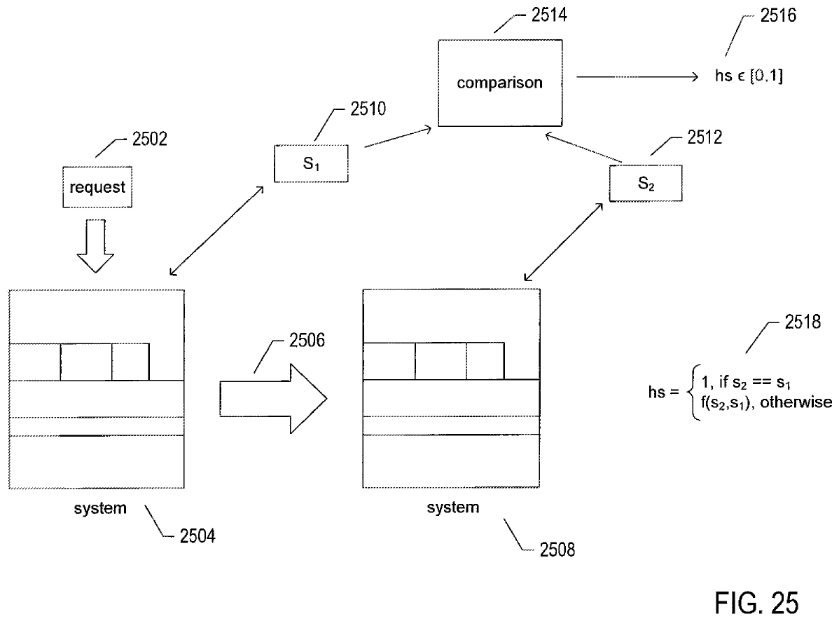

FIG. 25 illustrates a system-health-evaluation method that is used in implementations of the disclosed methods and systems, discussed below. The effect of a request 2502 on the health or operational status of a system is evaluated by this system-health-evaluation method. The system 2504 is placed into a known healthy initial state. The request is then allowed to be transmitted between an external entity and the system and/or between two internal components of the system, as represented by arrow 2506, leading to a potentially different state of the system 2508. The initial state of the system 2510 and the resultant state of the system 2512 are compared 2514 to produce a health status hs 2516 in the range of [0, 1]. As indicated by expression 2518, the health status has a value of 1 when the initial and resulting states are equal and, otherwise, has a computed value in the range [0, 1] indicating a degree to which the health of the system has been deleteriously impacted by receipt and processing of the request by one or more system components. A health status hs of 1 indicates that receipt and processing of the request has not deleteriously affected the system's health and a health status hs of 0 indicates that receipt and processing of the request has rendered the system inoperable or severely damaged. A health status hs may have intervening values that indicate, as intervening values approach 0, increasingly deleterious effects resulting from receiving and processing the request. The details of the comparison method 2514 vary widely with different types of computer systems and computer-system components, with different implementations of the comparison component considering different types of parameters and component states as well as different thresholds and ranges indicating deleterious health effects. Deleterious health effects include exhaustion of computational resources, such as memory capacity, processor bandwidth, and networking bandwidth available to application programs, but may also include undesired access to confidential data by external entities, corrupted data, the inability of application programs to receive and respond to requests, and many other such undesirable and deleterious effects. Certain of these effects can be easily monitored through the virtualization-layer and operating-system-level instrumentation, and other of the facts may be detected by various types of monitoring functionalities and probes. The actual implementation details, of course, are highly dependent on virtualization-layer, operating-system, and application implementations.

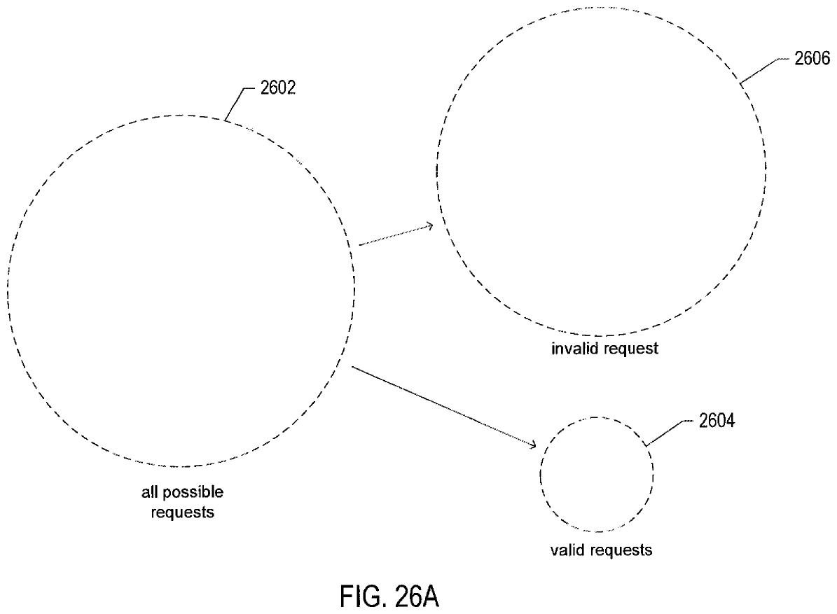

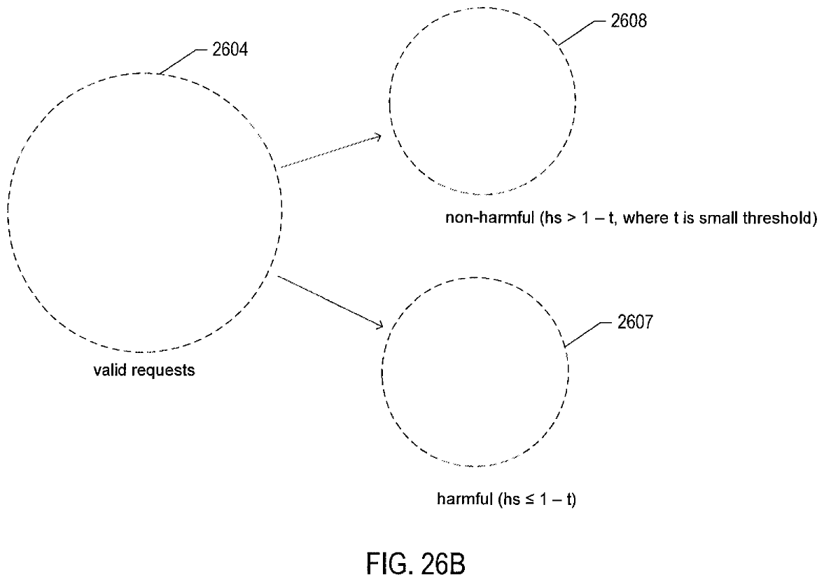

FIGS. 26A-B illustrate sets of vectors representing requests that a defender security component representing one implementation of the currently disclosed systems is trained to distinguish. As shown in FIG. 26A, and as previously discussed above, the set of all possible vectors representing all possible requests 2602 is partitioned into a relatively small set of valid requests 2604 and a generally much larger set of invalid requests 2606. The invalid requests can be allowed to be transmitted between system components or between external entities and system components without resulting harm to the system because invalid requests are recognized by the target component as invalid and are immediately rejected, without additional processing. By contrast, valid requests 2604 may be potentially harmful. As shown in FIG. 26B, the set of vectors corresponding to valid requests 2604 can be further partitioned into a set of vectors corresponding to harmful requests 2607 and a set of vectors corresponding to harmless requests 2608. The set of vectors corresponding to harmful requests 2607 are associated with hs values returned by the system-health-evaluation method, discussed above with reference to FIG. 25, that are less than or equal to 1−t, where t is a relatively small threshold value that may, in certain implementations, be equal to 0. The set of vectors corresponding to harmless requests 2608 are associated with hs values returned by the system-health-evaluation method that are greater than 1−t. The defender security component is trained to distinguish harmful requests 2606 from non-harmful and invalid requests 2607 and 2608.

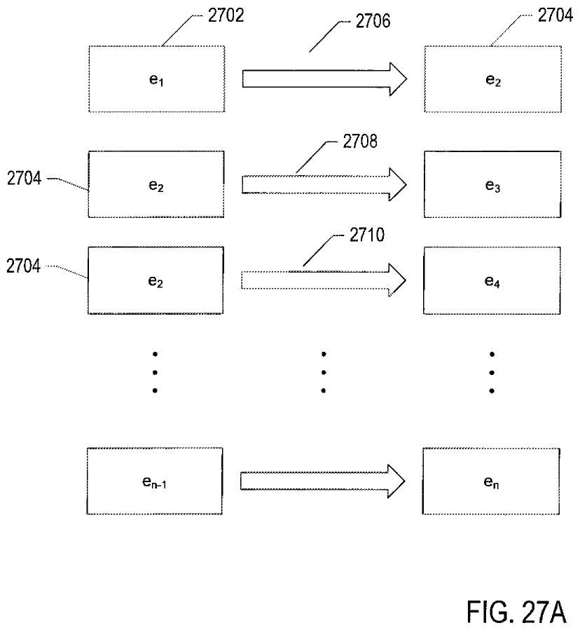

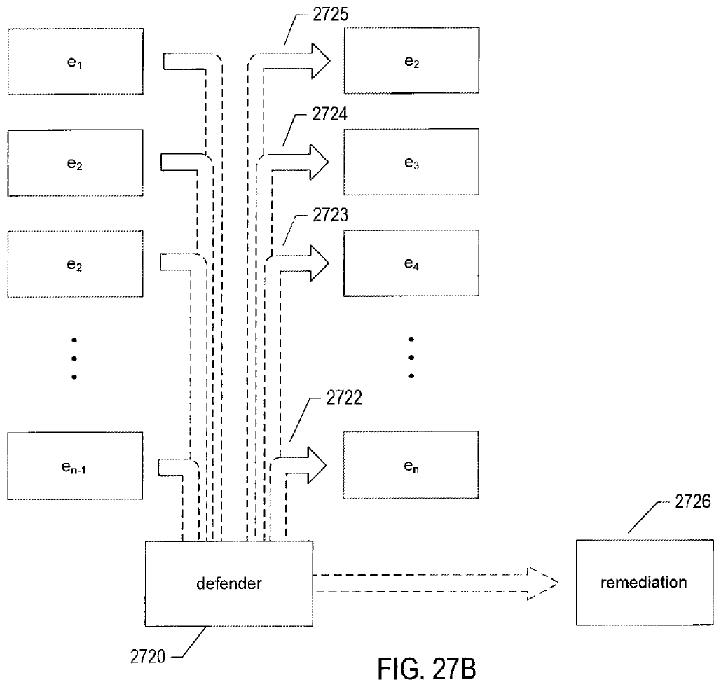

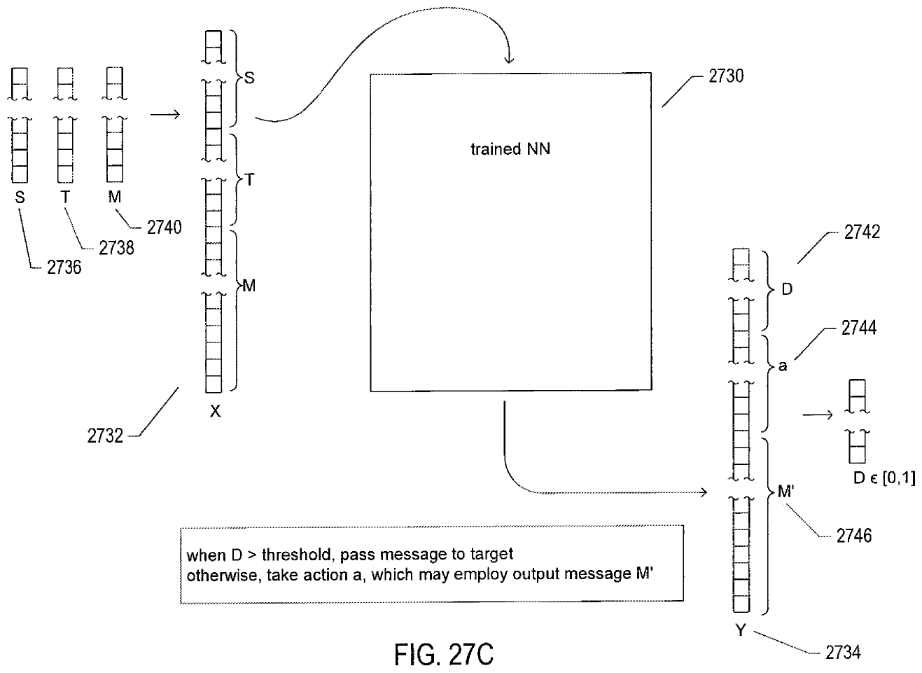

FIGS. 27A-C illustrate operation of the defender security component representing one implementation of the currently disclosed systems. As shown in FIG. 27A, the computer system or computer systems monitored by the defender include a number of communications between system components in which requests are transferred from a source component to a target component, such as source component 2702 and target component 2704. A target component, such as component 2704, may be a target with respect to one type of request and communications medium 2706 may be a source component for a different type of request and/or communications medium 2708. A source component, such as component 2704, may be a source with respect to two or more different types of requests, sources, and communications media 2708 and 2710 and, of course, a target component may be a target component with respect to two or more different types of requests, sources, and/or communications media. The defender is thus tasked with monitoring a number of one or more types of requests and communications media in order to detect harmful requests and ameliorate those harmful requests. As shown in FIG. 27B, the defender 2720 intercepts requests communicated from all of the monitored sources to all of the monitored targets. When the defender determines that a particular request is harmless, the defender allows the request to be forwarded to the original target of the request, as represented by arrows 2722-2725. However, when the defender determines that a particular request is harmful or potentially harmful, the requests is remediated 2726. Remediation may include simply blocking the request, but, depending on implementation, may also include modifying the request, delaying forwarding of the request, or any of other types of remedial actions that prevent system harm by the request.

FIG. 27C illustrates further details of one implementation of the defender security component. In this implementation, the defender security component 2730 is a trained neural network that receives an input vector x 2732 and outputs an output vector y 2734. In this implementation, the input vector x is constructed from a source-identifying vector S 2736, a target-identifying vector T 2738, and a request-message vector M 2740. The output vector y 2734 includes, in this implementation, a defender-decision component D 2742, an action component a 2744, and a request-message component M 2746. The component values are shown as vectors since the granularity of numerical values in the request vector may be such that multiple numerical values are combined to produce a single real value or other such value. The defender-decision component D is a representation of a real number in the range [0, 1], with 0 indicating that the message is certainly harmful, 1 indicating that the message is certainly harmless, and with intermediate values indicating increasing probabilities of harmfulness as the intermediate values decrease towards 0. In certain implementations, the defender itself may carry out the action returned as a component of the output vector y. In other implementations, the defender may direct the action to one or more additional components for execution, including a component that returns harmless requests to the communication link from which the request was intercepted and one or more remediation components that handle identified potentially harmful messages.

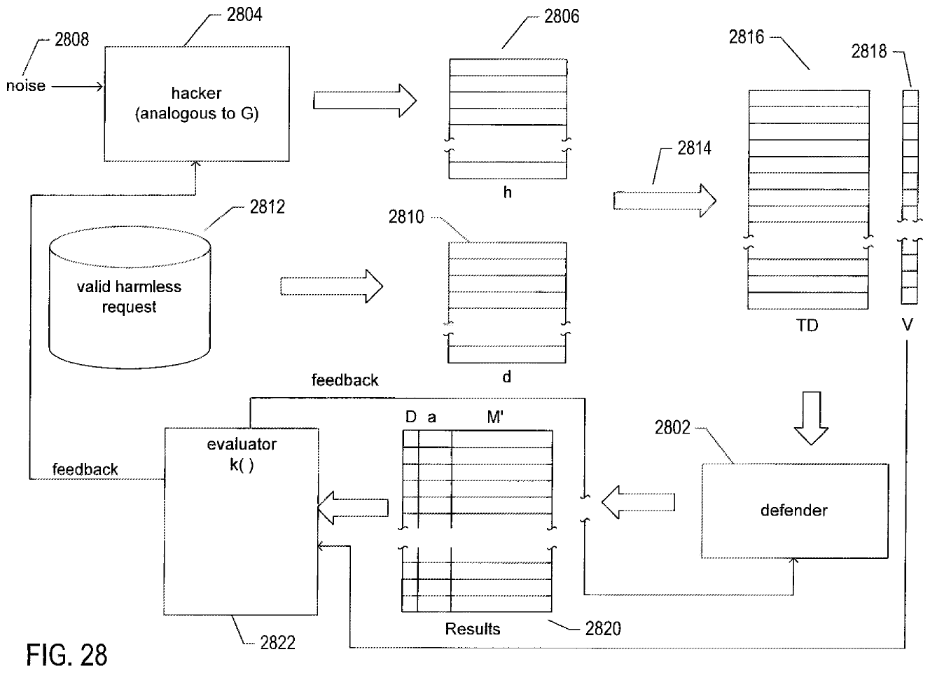

FIG. 28 illustrates how the defender neural network is trained using a training method similar to the above-discussed generative-adversarial-network training method. In addition to the defender 2802, a second hacker neural network 2804, analogous to the above-discussed generator G, produces synthetic, harmful requests 2806 in response to receiving noise vectors 2808. Thus, the hacker simulates a generative function that produces synthetic harmful requests 2806 for training purposes, just as the generator G of the above discussed generative-adversarial-network training method produces synthetic images that, when the generator G is well-trained, are difficult or impossible to be distinguished from actual photographs. A set of generally valid and harmless requests 2010 is selected, for training purposes, from a database of actual requests 2012 previously submitted to components of the system. These are referred to as “Data requests” or “data vectors.” The set of synthetic, harmful requests and the set of data requests are sampled 2014 to produce a training data set 2860. In addition, each request is the training data set is associated with a Boolean valid indicator, shown in a valid vector 2818, that indicates whether or not the request is obtained from the set of data requests 2810. The requests in the training data set 2816 are input to the defender 2802, during training, which produces a corresponding set of results 2020. These results, along with the corresponding valid vector 2818, are input to an evaluator 2022, represented by a function k( ), discussed below, which generates a value directly related to an objective value, or to an error value related to the objective value, to which a gradient operator is applied in order to provide feedback to the hacker neural network 2804 and the defender neural network 2802, as in the above-discussed generative-adversarial-network training method. Once the training is completed, the defender is installed into a system to monitor communications of requests between external entities and the system and/or between components within the system and to direct remediation of identified harmful request messages, as discussed above with reference to FIGS. 27A-C.

There is a large number of information sources and methodologies that can be used both by the hacker, to facilitate generation of harmful, synthetic requests, and by the defender to recognize potentially harmful requests. The defender and hacker can be provided with information regarding productive approaches to generating harmful requests gleaned from source code, including source-code implementations of application programs, operating systems, and virtualization layers. This type of information may also be gleaned from various open-source libraries, documentation of APIs and service interfaces as well as from proprietary and open-source security tools intended to monitor for, and ameliorate, various types of security threats. There are number of vulnerability databases that have been compiled by developers and vendors to identify particular types of security threats. Finally, user feedback and user-provided information obtained through various interfaces can also be used.

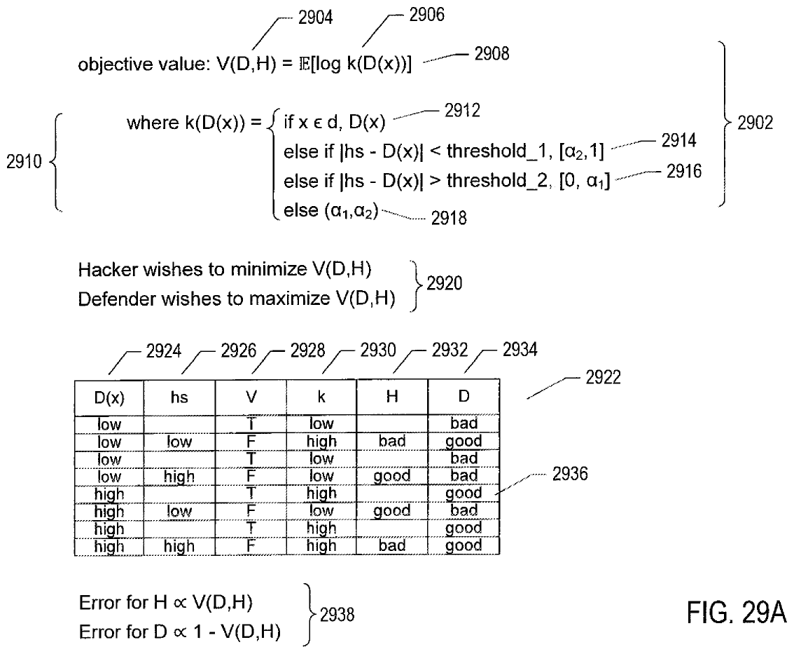

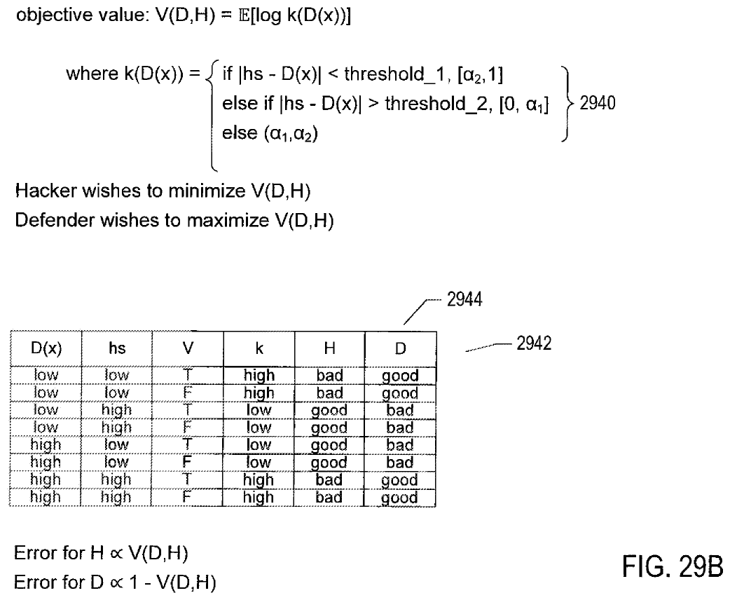

FIGS. 29A-B illustrate two different objective values that control adversarial training of the defender security component that represents an implementation of the currently disclosed systems. This objective value can be compared with the objective value 2222 discussed above with reference to FIG. 22 for the generative-adversarial-network training method to understand important differences between the above-describe generative-adversarial-network training method and the currently disclosed adversarial-training method for the currently disclosed defender security component. It should be noted that, for simplicity of description, only training based on the defender-decision D(x) is discussed. When the defender also generates an action and/or modified request message, these quantities are also incorporated into the objective-value expression.

A first objective value is shown by expressions 2902 in FIG. 29A. The objective value for a particular training state of the defender D and hacker H. V(D,H) 2904, is the estimated value of the logarithm of the results of the evaluator function k applied to the defender-decision D(x) returned by the defender for an input training-data set request x, as shown by the single term 2906 in expression 2908. Expression 2910 defines the evaluator function k( ). When the training-data set vector x was obtained from the set of data vectors, the function k( ) returns the defender-decision D(x), as indicated by a subexpression 2912. Otherwise, the request is evaluated by the system-health-evaluation method discussed above with reference to FIG. 25 to generate an hs value. When the difference between the generated hs value and the defender-decision D(x) is less than a first threshold value, indicating that the defender has accurately characterized the request, the function k( ) returns a value close to, or equal to, 1, as shown by subexpression 2914. When the difference between the generated hs value and the defender-decision D(x) is greater than a second threshold value, indicating that the defender has seriously mischaracterized the nature of the request x, the function k( ) returns 0 or a value close to 0, as shown by subexpression 2916. Otherwise, the function k( ) returns a value intermediate between 0 and 1, as shown by subexpression 2918, with values closer to 0 indicating increasing degrees of mischaracterization of the nature of the request x. The hacker is trained to minimize V(D,H) while the defender is trained to maximize V(D,H), as shown in FIG. 29 A by expressions 2920. Thus, adversarial training of the defender is, like the above-discussed generative-adversarial-training method, a minimax-like optimization.

Table 2922 illustrates the meaning of the objective value defined by expression 2908. Each row in this table represents the relative values of terms that contribute to the objective value for a particular training-data request as well as indications for the desirability of the resulting objective value to the hacker and defender. The columns of the table include: (1) 2924, the relative value of the defender-decision D(x); (2) 2926, the relative value of the hs value returned by the system-health-evaluation method discussed above with reference to FIG. 25; (3) 2928, the valid indication for the training-data set request x; (4) 2930, the relative value returned by the function k( ), which is also the relative value of the objective value V(D,H); (5) 2932, an indication of whether or not the outcome is good or bad for the hacker; and (6) 2934, an indication of whether or not the outcome is good or bad for the defender. In the implementation defined by the objective value expressed in equation 2908, including the function k( ) defined by expression 2910, a valid and harmless training-data set request is not evaluated with respect to the effects on system health, while synthetic requests generated by the hacker are so evaluated. This leads to efficiency in training since the system-health evaluation may be time-consuming and involve significant computational overheads. However, it also leads to certain outcomes that may be undesirable. For example, consider row 2936 in table 2922. In this case, the defender-decision D(x) has a high-value and, therefore, the function k( ) returns a high-value which appears to represent a desirable outcome for the defender. But what if, in fact, had the training-data set request been evaluated to generate a hs value, and the hs value turned out to be low? In this case, the defender may not be adequately trained to recognize a harmful message that was submitted by a legitimate user. As indicated by expressions 2938, the error used for computing gradients for the hacker is proportional to V(D,H) and the error used for computing gradients for the defender is proportional to 1−V(D,H).

FIG. 29B provides a second objective value used in an alternative implementation of the adversarial-training method for training the defender. This method is similar to the method represented by the objective value discussed with respect to FIG. 29A, with the exception that all training-data set request vectors are evaluated by the system-health-evaluation method discussed above with reference to FIG. 25, rather than only the synthetic requests generated by the hacker, as in the method discussed with respect to FIG. 29A. This simplifies the expression 2940 that defines the function k(and fully fills the entries in table 2942, equivalent, in structure, to table 2922 shown in FIG. 29 A. In this implementation, it can be seen that the indication of whether or not the result is desirable to the defender, shown in the final column 2944 of table 2942, faithfully tracks the value returned by the function k( ), which means that the defender is trained to block or remediate all harmful requests, regardless of whether or not the harmful requests were sampled from the synthetic requests generated by the hacker or the actual requests sampled from an actual request database.

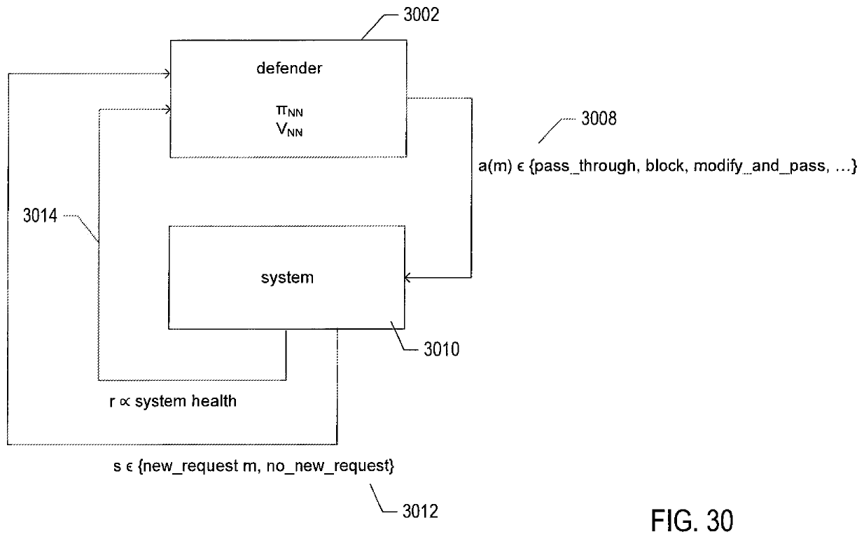

FIG. 30 shows an alternative implementation of the defender based on reinforcement learning. In this implementation the defender 3002 is a reinforcement-learning-based agent, which implements both the policy 3004 and the value function 3006 with neural networks. The defender issues an action 3008 for each intercepted request message indicating whether or not to pass through the request message or remediate the request message by blocking the request, modifying the request, or by other remedial actions. The environment, or system 3010 returns a status to the defender that indicates whether or not a new request message has been intercepted 3012, in addition to other status information, and returns a reward 3014 based on the system health. The reinforcement-learning-based defender may be additionally initially trained using an adversarial-training method. In yet other implementations, reinforcement learning may be combined with adversarial-generative-training implementations for continuous training of the defender.

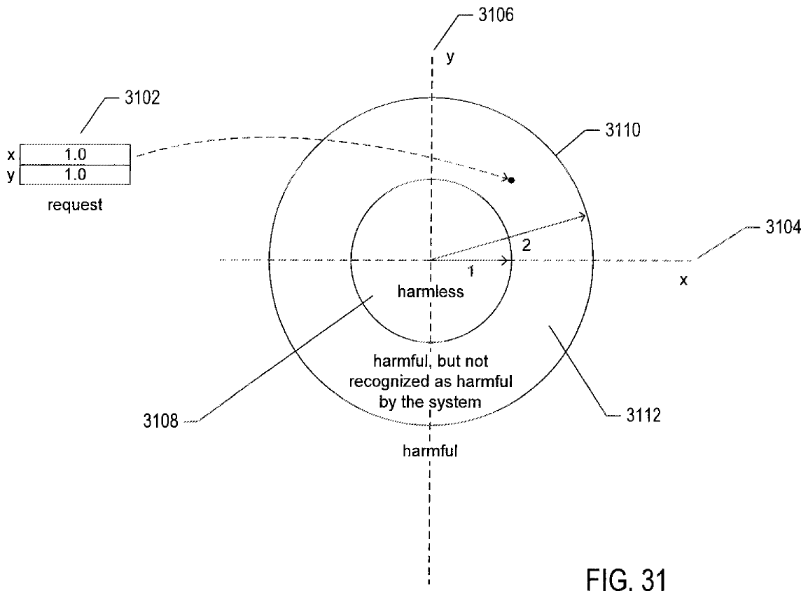

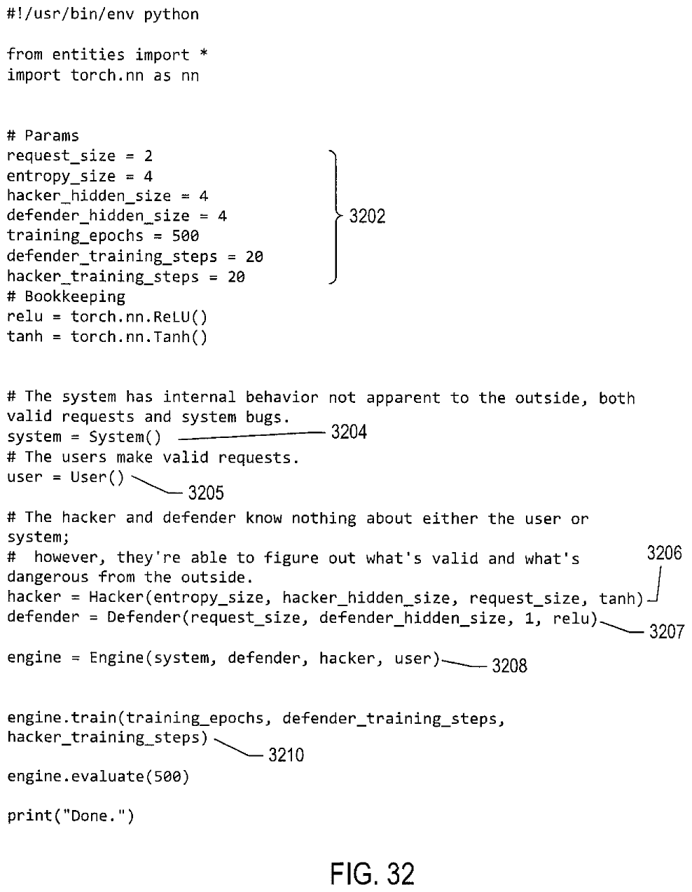

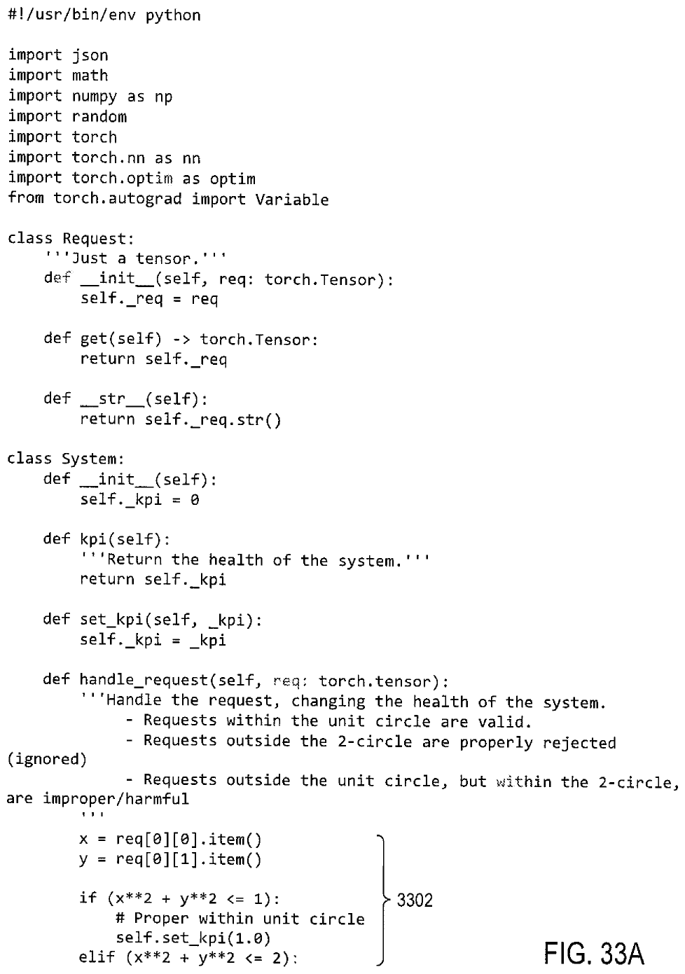

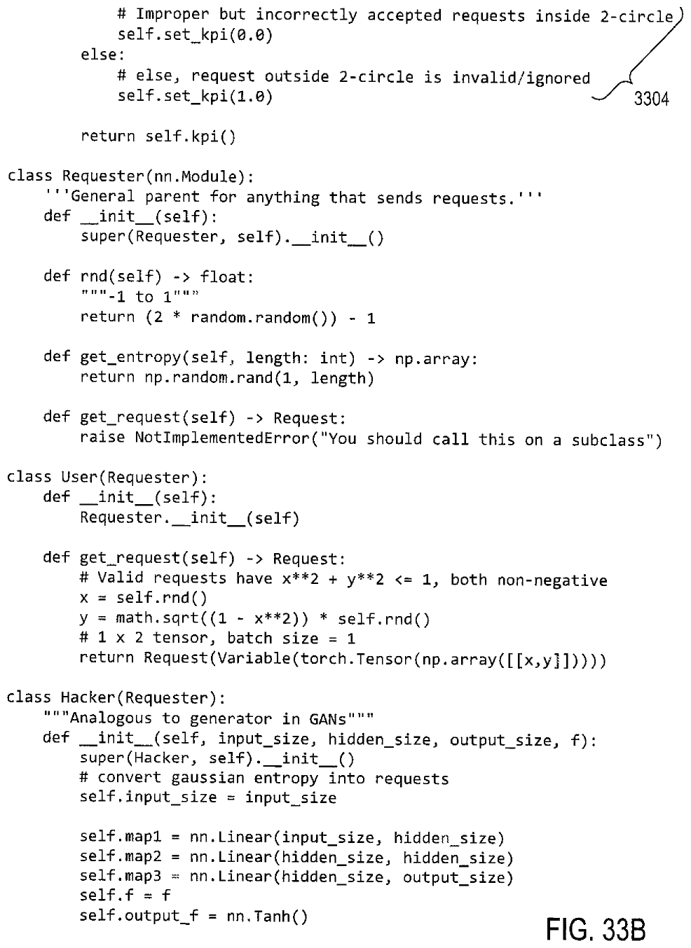

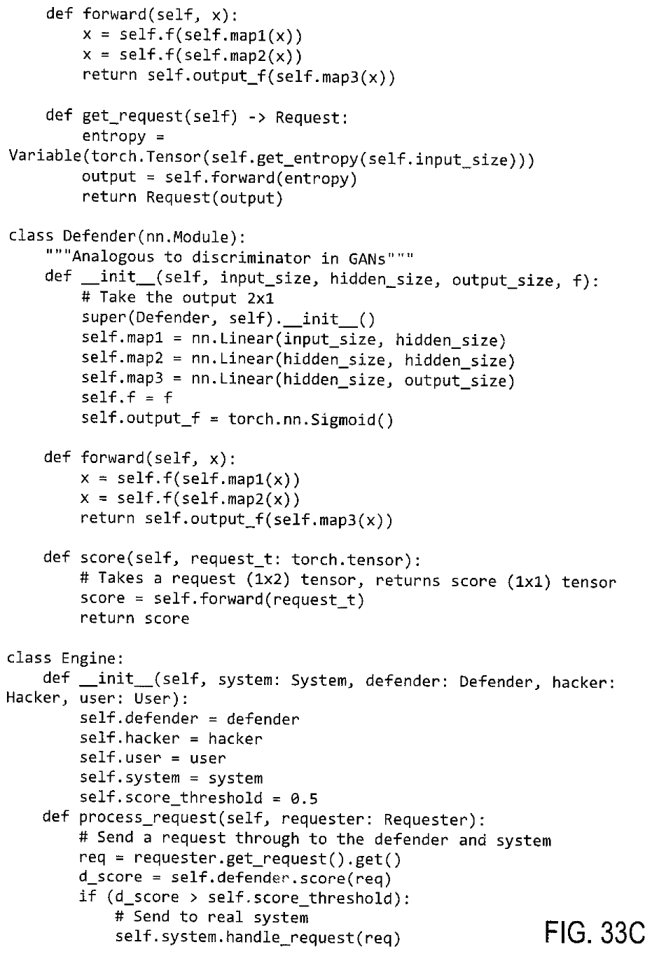

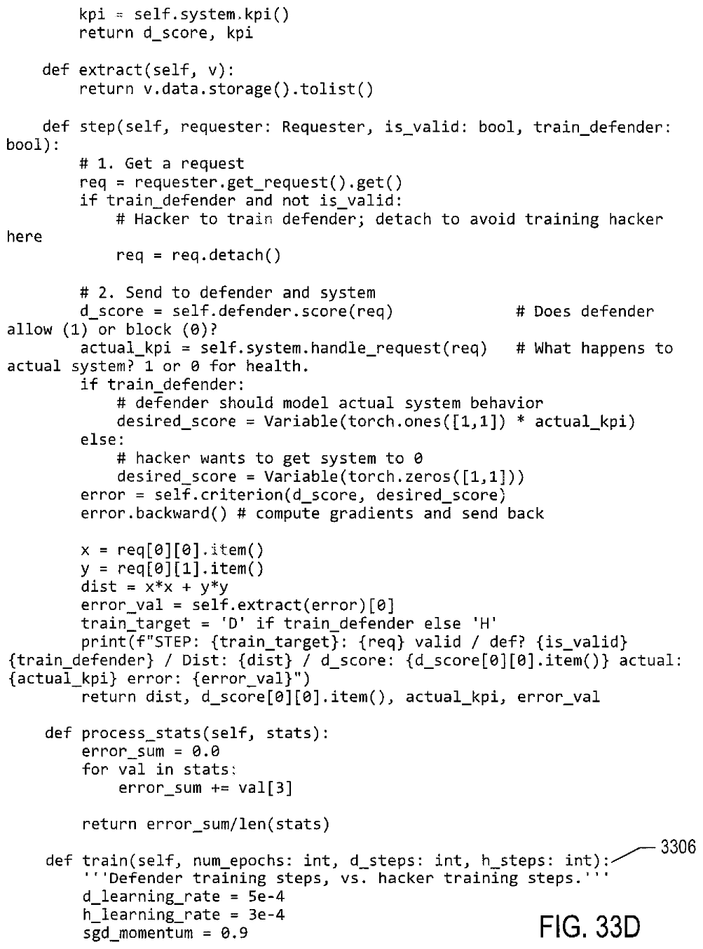

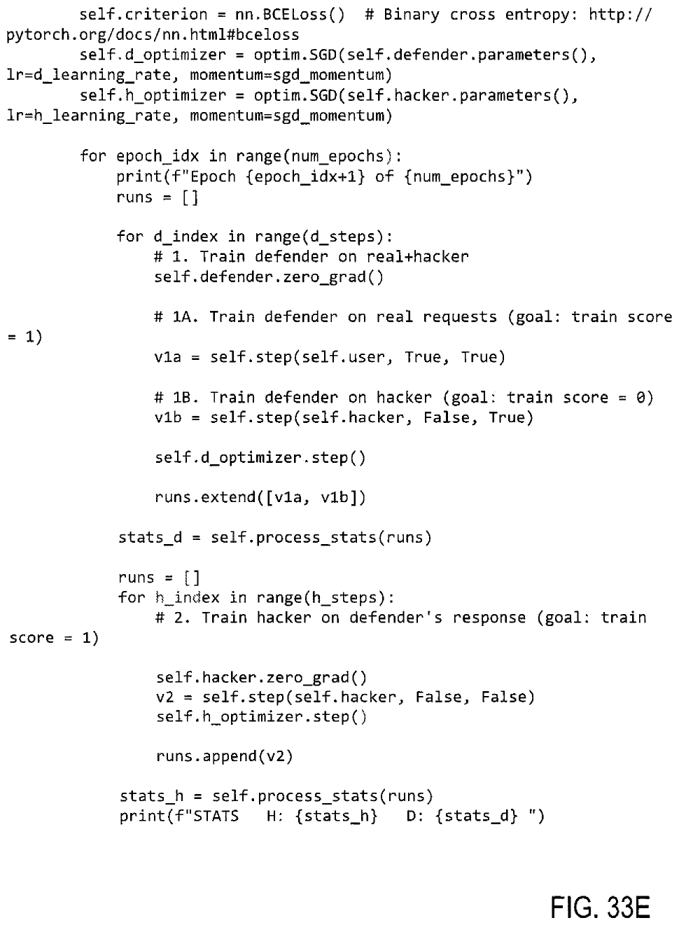

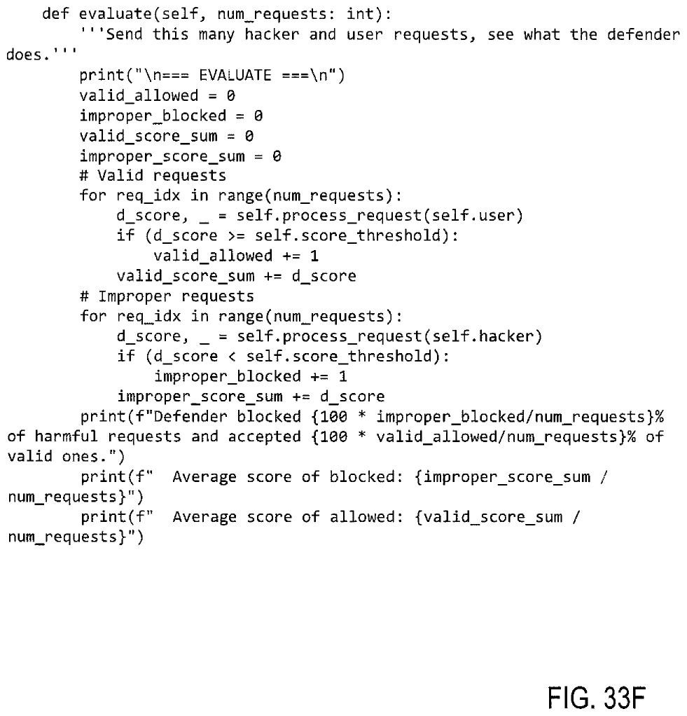

FIG. 31 illustrates a simple model for evaluating the harmfulness of requests used in an illustrative implementation shown in FIGS. 32-33F. In this illustrative implementation, each request is represented as a two-element vector 3102 that contains a first value x and a second value y. To ascertain whether or not the vector is harmful, the x and y values are used as coordinates, with respect to x 3104 and y 3106 coordinate axes to map the request to a plane. When the mapped request falls within an area bounded by the unit circle 3108, the request is considered to be harmless and, otherwise, the request is considered to be harmful. The system recognizes requests outside of a circle 3110 with radius 2 as harmful, but incorrectly considers requests in the circular band 3112 between the unit circle and the circle with radius 2 to be harmless, even though they are harmful. Thus, the system is faulty and insecure.

FIGS. 32-33F provide a Python illustrative implementation of defender and hacker training. This implementation is not discussed, in great detail, below. FIG. 32 shows a main function for the illustrative implementation. The number of constant-valued parameters are initially defined 3202, a system 3204, user 3205, hacker 3206, defender 3207, and engine 3208 are instantiated, and an engine training method is called 3210 to train the defender and the hacker by an adversarial training method, as discussed above. FIGS. 33A-F provide implementations of the system, user, hacker, defender, and engine classes. The harmfulness of a request, as discussed above with reference to FIG. 31, is evaluated in a first portion 3302 of FIG. 33A and a second portion 3304 of FIG. 33B. The engine training function member is defined beginning on line 3306 in FIG. 33D. This implementation was run to show that, in fact, adversarial training of the defender and hacker produces a defender that accurately blocks requests falling outside of the unit circle, when plotted as shown in FIG. 31. Thus, the defender is able to protect the system even though the system is unable to recognize the harmfulness of the messages in the circular band 3112 discussed above with reference to FIG. 31.

The present invention has been described in terms of particular embodiments, it is not intended that the invention be limited to these embodiments. Modifications within the spirit of the invention will be apparent to those skilled in the art. For example, any of many different implementations of the log/event-message system can be obtained by varying various design and implementation parameters, including modular organization, control structures, data structures, hardware, operating system, and virtualization layers, and other such design and implementation parameters. For example, as discussed above, a variety of different machine-learning an artificial-intelligence methods and techniques can be employed for implementation of the defender. As also discussed above, a wide variety of different types of security-related information sources can be employed in order to assist the defender in recognizing potentially harmful requests. While the discussion in this document has focused on requests communicated from one internal component of the computer system to another internal component of a computer system or from external entities to a component of the computer system, defenders can be constructed and trained to monitor all types of communications that result in exchange of data between system components.

1. A security subsystem within a computer system that includes one or more discrete, component computer systems that each have one or more processors, one or more memories, and one or more mass-storage devices, the security subsystem comprising:
one or more communications links, each communication link transferring one or more requests from a source internal-computer-system component to a target internal-computer-system component, from a source external entity to a target internal-computer-system component, or from a source internal-computer-system component to a target external entity; and
a machine-learning-based defender, trained by adversarial training, that
monitors the communications links by intercepting requests being transferred from sources to targets,
determines whether or not the intercepted requests are potentially harmful to the system,
when a request is determined to be potentially harmful, remediates the request, and
when a request is determined to be harmless, directs the request back into the communications link for transmission to the target.

2. The security subsystem within a computer system of claim 1 wherein the defender includes a machine-learning component to which a request is input and which, in response to an input request, returns a defender decision indicating whether or not the request is harmful.

3. The security subsystem of claim 2 wherein the defender decision is a real number in the range [0,1], with the extreme values 0 and 1 indicating certainty is the decision and intermediate values range indicating degrees of uncertainty in the decision.

4. The security subsystem of claim 3
wherein a defender decision with value 0 indicates that the request is certainly harmful;
wherein a defender decision with value 0.5 indicates that no determination of whether the request is harmful or harmless has been made;
wherein a defender decision with value 1.0 indicates that the request is certainly harmless;
wherein, as the value of a defender decision increases from 0 towards 0.5, the defender decision indicates that the request is harmful with decreasing certainty; and
wherein, as the value of a defender decision increases from 0.5 towards 1.0, the defender decision indicates that the request is harmless with increasing certainty.

5. The security subsystem of claim 3 wherein the defender further returns, in response to an input request, an action.

6. The security subsystem of claim 5 wherein the action is one of:
a pass-through action that indicates that the request should be returned to the communications link for transfer to the target; and
a block action that indicates that the request should not be returned to the communications link for transfer to the target.

7. The security subsystem of claim 6 wherein additional actions include:
a modify action indicating that the request should be modified before being returned to the communications link for transfer to the target.

8. The security subsystem of claim 3 wherein the defender further returns, in response to an input request, a modified request.

9. The security subsystem of claim 3 wherein the machine-learning component is a neural network.

10. The security subsystem of claim 9 wherein the defender is trained concurrently with a hacker, which also includes a neural network, by the adversarial training process.

11. The security subsystem of claim 9 wherein the adversarial training process uses an objective value which the defender is trained to maximize and which the defender is trained to minimize.

12. The security subsystem of claim 11 wherein the objective value is an estimated value of the logarithm of a value returned by an evaluator function k( ) applied to a defender decision returned from a training-data request.

13. The security subsystem of claim 12 wherein the evaluator function k( ) returns values in the range [0, 1] inversely related to the magnitude of the difference between the defender decision and a system-health indication returned by a system-health-evaluation process.

14. The security subsystem of claim 12 wherein the system-health-evaluation process comprises:
submitting the request to a system in an initial state with an initial health;
determining the resultant health of the system following processing of the request; and
comparing the initial health to the resultant health to return a system-health indication in the range [0, 1] indicating the degree to which the system is deleteriously affected by processing the request.

15. The security subsystem of claim of claim 10 wherein the hacker simulates a generative function that generates simulated, harmful request.

16. The security subsystem of claim 15 wherein simulated harmful requests generated by the hacker are combined with data requests sampled from a collection of requests observed in a functioning system to generate training-data requests that are submitted to the defender.

17. A method that secures a computer system that includes one or more discrete, component computer systems that each have one or more processors, one or more memories, and one or more mass-storage devices, the method comprising:
incorporating a machine-learning-based defender, trained by adversarial training, into the computer system;
intercepting, by the defender, requests transferred in one or more communications links, each communication link transferring one or more requests from a source internal-computer-system component to a target internal-computer-system component, from a source external entity to a target internal-computer-system component, or from a source internal-computer-system component to a target external entity;
determining, by the defender, whether each intercepted request is potentially harmful;
when a request is determined to be potentially harmful, remediating the request; and
when a request is determined to be harmless, directs the request back into the communications link from which the request was intercepted for transmission to the target.

18. The method of claim 17 wherein the defender remediates a potentially harmful request by remediation actions that include:
blocking the request; and
modifying the request before directing the request back into the communications link from which the request was intercepted for transmission to the target.

19. A physical data-storage device encoded with computer instructions that, when executed by one or more processors within a computer system that includes one or more discrete, component computer systems that each have one or more processors, one or more memories, and one or more mass-storage devices, controls the computer system to:
instantiate a machine-learning-based defender, trained by adversarial training;
intercept, by the defender, requests transferred in one or more communications links, each communication link transferring one or more requests from a source internal-computer-system component to a target internal-computer-system component, from a source external entity to a target internal-computer-system component, or from a source internal-computer-system component to a target external entity;
determine, by the defender, whether each intercepted request is potentially harmful;
when a request is determined to be potentially harmful, remediate the request; and
when a request is determined to be harmless, direct the request back into the communications link from which the request was intercepted for transmission to the target.

20. The security subsystem of claim 19 wherein remediating a potentially harmful request comprises execution of a remediation action, wherein remediation actions that include blocking the request and modifying the request before directing the request back into the communications link from which the request was intercepted for transmission to the target.
